(19) United States
(12) Patent Application Publication
(10) Pub. No.: US 2026/0228837 A1
(43) Pub. Date: Aug. 6, 2026

(54) PEAK PREDICTION FOR GLOBAL ADJUSTMENT OF ELECTRICAL SYSTEMS, AND RELATED SYSTEMS, APPARATUSES, AND METHODS

(71) Applicant: Enel X North America, Inc., Boston, MA (US)

(72) Inventors: Cesar A. Silva-Monroy, Selah, WA (US); Brendan P. Sinnott, Bend, OR (US); Shane R. Daly, Los Alamos, NM (US)

(73) Assignee: Enel X North America, Inc., Boston, MA (US)

(21) Appl. No.: 19/153,302

(22) PCT Filed: Feb. 15, 2024
(86) PCT No.: PCT/US2024/016046

§ 371 Date: Aug. 1, 2025

Related U.S. Application Data
(60) Provisional application No. 63/446,727, filed on Feb. 17, 2023.

(51) Int. Cl. G06Q 50/06

(52) U.S. Cl. CPC G06Q 50/06

(57) ABSTRACT

Systems, apparatuses, and methods may predict utility peak events associated with a system peak utility program and determine a probabilistic forecast to be used as a parameter for a cost function. The cost function may be used to determine one or more parameters to effectuate a change to the electrical system to attempt to participate in a system peak utility program.

### RELATED APPLICATIONS

The present application claims the benefit of priority under 35 U.S.C. Section 119 (e) of U.S. Provisional Patent Application No. 63/446,727 entitled PEAK PREDICTION FOR GLOBAL ADJUSTMENT OF ELECTRICAL SYSTEMS, AND RELATED SYSTEMS, APPARATUSES, AND METHODS, filed Feb. 17, 2023, which is hereby incorporated by reference herein in its entirety.

### TECHNICAL FIELD

The present disclosure is directed to systems and methods for control of an electrical system, and more particularly to controllers and methods of controllers for controlling an electrical system.

### BACKGROUND

Electricity supply and delivery costs continue to rise, especially in remote or congested areas. Moreover, load centers (e.g., population centers where electricity is consumed) increasingly demand more electricity. In the U.S., energy infrastructure is such that power is mostly produced by resources inland, and consumption of power is increasing at load centers along the coasts. Thus, transmission and distribution (T&D) systems are needed to move the power from where it is generated to where it is consumed at the load centers. As the load centers demand more electricity, additional T&D systems are needed, particularly to satisfy peak demand. However, a major reason construction of additional T&D systems is unwise and/or undesirable is because full utilization of this infrastructure is really only necessary during relatively few peak demand periods, and would otherwise be unutilized or underutilized. Justifying the significant costs of constructing additional T&D resources may make little sense when actual utilization may be relatively infrequent.

Distributed energy storage is increasingly seen as a viable means for minimizing rising costs by storing electricity at the load centers for use during the peak demand times. An energy storage system (ESS) can enable a consumer of energy to reduce or otherwise control a net consumption from an energy supplier. For example, if electricity supply and/or delivery costs are high at a particular time of day, an ESS, which may include one or more batteries or other storage devices, can generate/discharge electrical energy at that time when costs are high in order to reduce the net consumption from the supplier. Likewise, when electricity rates are low, the ESS may charge so as to have reserve energy to be utilized in a later scenario as above, when supply and/or delivery costs are high.

An automatic controller may be beneficial to reduce costs of operation of an electrical system during peak demand times.

### BRIEF DESCRIPTION OF THE DRAWINGS

Additional aspects and advantages will be apparent from the following detailed description of preferred embodiments, which proceeds with reference to the accompanying drawings, in which:

FIG. 1 is a block diagram illustrating a system architecture of a controllable electrical system, according to one embodiment of the present disclosure.

FIG. 2 is a flow diagram of a method or process of controlling an electrical system, according to one embodiment of the present disclosure.

FIG. 3 is a block diagram illustrating a system architecture of a controllable electrical system, according to one embodiment of the present disclosure.

FIG. 4A is a flow diagram of a global adjust controller (GA) process.

FIG. 4B is a flow diagram of a method or process of controlling an electrical system, according to one embodiment of the present disclosure.

FIG. 5 is a flow diagram of a method of predicting load and/or generation of an electrical system during an upcoming time domain, according to one embodiment of the present disclosure.

FIG. 6 illustrates a block diagram of a GA, according to one embodiment of the present disclosure.

FIG. 7 is a graph illustrating example load data of a utility or Independent System Operator (ISO).

FIG. 8 illustrates an example forecasted utility load.

FIG. 9A illustrates a probabilistic forecast comprising probabilities for the two peak hours of the forecasted utility load of FIG. 8.

FIG. 9B illustrates a probabilistic forecast in which the GA renormalizes the probabilities.

FIG. 9C illustrates a probabilistic forecast comprising CMs for each of the hours of the forecasted utility load of FIG. 8.

FIG. 9D illustrates a probabilistic forecast according to another embodiment.

FIG. 9E Illustrates a probabilistic forecast 900E with padded probabilities.

FIG. 10 is a diagrammatic representation of a cost function evaluation module, according to one embodiment of the present disclosure.

FIG. 11 is a flow diagram of a method of preparing a cost function fc (X), according to one embodiment of the present disclosure.

FIG. 12 is a flow diagram of a method of evaluating a cost function that is received from an external source or otherwise unprepared, according to one embodiment of the present disclosure.

FIG. 13 is a flow diagram of a method of evaluating a prepared cost function, according to one embodiment of the present disclosure.

FIG. 14 is a diagrammatic representation of an optimizer that utilizes an optimization algorithm to determine an optimal control parameter set.

FIG. 15 is a diagram of an GA, according to one embodiment of the present disclosure.

FIG. 16 is a diagram of an EO, according to one embodiment of the present disclosure.

FIG. 17 is a diagram of a dynamic manager, according to one embodiment of the present disclosure.

### DETAILED DESCRIPTION

As electricity supply and delivery costs increase, especially in remote or congested areas, distributed energy storage is increasingly seen as a viable means for reducing those costs. The reasons are numerous, but primarily an energy storage system (ESS) gives a local generator or consumer the ability to control net consumption and delivery of electrical energy at a point of interconnection, such as a building's service entrance in example implementations where an ESS is utilized in an apartment building or office building. For example, if electricity supply and/or delivery costs (e.g., charges) are high at a particular time of day, an ESS can generate/discharge electrical energy from a storage system at that time to reduce the net consumption of a consumer (e.g., a building), and thus reduce costs to the consumer. Likewise, when electricity rates are low, the ESS may charge its storage system, which may include one or more batteries or other storage devices; the lower-cost energy stored in the ESS can then be used to reduce net consumption and thus reduce costs to the consumer at times when the supply and/or delivery costs are high. There are many ways an ESS can provide value.

One possible way in which ESSs can provide value is by reducing demand charges. Demand charges are electric utility charges that are based on the rate of electrical energy consumption (also called “demand”) during particular time windows (called “demand windows” herein). A precise definition of demand and the formula for demand charges may be defined in a utility's tariff document. For example, a tariff may specify that demand be calculated at given demand intervals (e.g., 15-minute intervals, 30-minute intervals, 40-minute intervals, 60-minute intervals, 120-minute intervals, etc.). The tariff may also define demand as being the average rate of electrical energy consumption over a previous period of time (e.g., the previous 15 minutes, 30 minutes, 40 minutes, etc.). The previous period of time may or may not coincide with the demand interval. Demand may be expressed in units of power such as kilowatts (KW) or megawatts (MW). The tariff may describe one or more demand rates, each with an associated demand window (e.g., a period of time during which a demand rate applies). The demand windows may be contiguous or noncontiguous and may span days, months, or any other total time interval per the tariff. Also, one or more demand windows may overlap, which means that, at a given time, more than one demand rate may be applicable. Demand charges for each demand window may be calculated as a demand rate multiplied by the maximum demand during the associated demand window. Demand rates in the United States may be expressed in dollars per peak demand ($/KW). As can be appreciated, demand tariffs may change from time to time, or otherwise vary, for example annually, seasonally, monthly, or daily. An automatic controller may be beneficial and may be desirable to enable intelligent actions to be taken as frequently as may be needed to utilize an ESS to reduce demand charges.

Another possible way in which ESSs can provide value is through improving utilization of local generation by: (a) maximizing self-consumption of renewable energy, or (b) reducing fluctuations of a renewable generator such as during cloud passage on solar photovoltaic arrays. An automatic controller may be beneficial and may be desirable to enable intelligent actions to be taken to effectively and more efficiently utilize locally generated power with an ESS.

Another possible way in which ESSs can provide value is through leveraging local contracted or incentive maneuvers. For example, New York presently has available a Demand Management Program (DMP) and a Demand Response Program (DRP). These programs, and similar programs, offer benefits (e.g., a statement credit) or other incentives for consumers to cooperate with the local utility (ies). An automatic controller may be beneficial and may be desirable to enable intelligent actions to be taken to utilize an ESS to effectively leverage these contracted or incentive maneuvers.

Still another possible way in which ESSs can provide value is through providing reserve battery capacity for backup power in case of loss of supply. An automatic controller may be beneficial and may be desirable to enable intelligent actions to be taken to build and maintain such reserve battery backup power with an ESS.

Another possible way in which ESSs can provide value is through improving utilization of a battery within the ESSs. For example, a company servicing the ESS may replace the battery after a target number of years (e.g., warranty period). The ESS can provide value by causing the battery to be used enough that a target battery capacity is reached at the target number of years.

As can be appreciated, an automatic controller that can automatically operate an electrical system to reduce demand charges using an ESS may be desirable and beneficial.

### System Peak Utility Programs

One example of a local contracted or incentive maneuver is a system peak utility program. System peak utility programs are incentives such that a behind-the-meter site is paid if the site is able to curtail site electricity load when the total electricity load of a utility or an Independent System Operator (ISO) is at its highest (i.e., a utility peak).

Typically, these programs reward sites that curtail their load during a specified number of utility electricity peaks annually. For example, the top X number of utility electricity peaks annually may be used to determine which sites deserve the incentive. In some programs each peak is the average utility demand over one hour and no two peaks can happen on the same day. Currently in the Ontario Global Adjustment program, sites are rewarded for lowering site electricity load during the top five electricity peaks of the utility. A utility electricity peak of a system peak utility program may also be referred to herein as a utility electricity peak or a utility peak event.

One challenging aspect of participating in a system peak program is that participants are not made aware of when system peaks will occur. Therefore, it is difficult to determine when such an incentive is available.

Some embodiments herein control a battery or other controllable load to participate in the system peak program in addition to considering other site value streams. The embodiments may help the site owner achieve maximum economic value of their battery or controllable load while their site is enrolled in a system peak program. The embodiments may predict the system peaks and dispatch information related to a system peak incentive to an electrical system controller.

### Controlling Electrical Systems

An electrical system, according to some embodiments, may include one or more electrical loads, generators, and ESSs. An electrical system may include all three of these components (loads, generators, ESSs), or may have varying numbers and combinations of these components. For example, an electrical system may have loads and an ESS, but no local generators (e.g., photovoltaic, wind). The electrical system may or may not be connected to an electrical utility distribution system (or “grid”). If not connected to an electrical utility distribution system, it may be termed “off-grid.”

An ESS of an electrical system may include one or more storage devices and any number of power conversion devices. The power conversion devices are able to transfer energy between an energy storage device and the main electrical power connections that in turn connect to the electrical system loads and, in some embodiments, to the grid. The energy storage devices may be different in different implementations of the ESS. A battery is a familiar example of a chemical energy storage device. For example, in one embodiment of the present disclosure, one or more electric vehicle batteries are connected to an electrical system and can be used to store energy for later use by the electrical system. A flywheel is an example of a mechanical energy storage device.

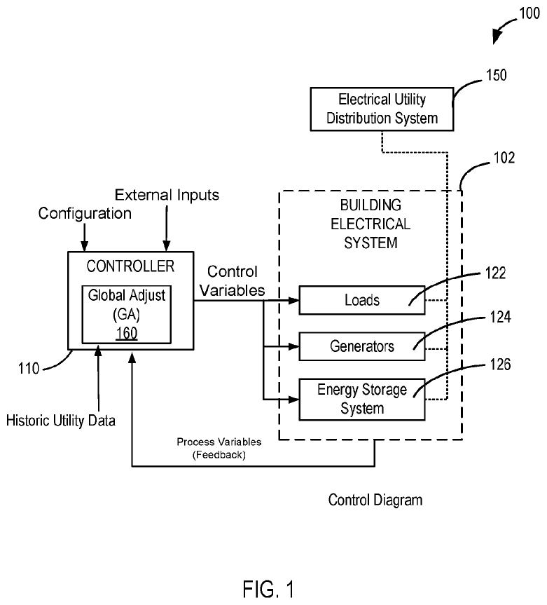

FIG. 1 is a control diagram of an electrical system 100, according to one embodiment of the present disclosure. Stated otherwise, FIG. 1 is a representative diagram of a system architecture of an electrical system 100 including a controller 110, according to one embodiment. The electrical system 100 comprises a building electrical system 102 (sometimes called the “plant”) that is controlled by the controller 110. The building electrical system 102 includes one or more loads 122, one or more generators 124, and an energy storage system (ESS) 126. The building electrical system 102 is coupled to an electrical utility distribution system 150, and therefore may be considered on-grid. Similar electrical systems exist for other applications such as a photovoltaic generator plant and an off-grid building.

In the control diagram of FIG. 1, the controller 110 is shown on the left-hand side and the building electrical system 102, sometimes called the “plant,” is on the right-hand side. The controller 110 may include electronic hardware and software in one embodiment. In one example arrangement, the controller 110 includes one or more processors and suitable storage media, which store programming in the form of executable instructions that are executed by the processors to implement the control processes. In some embodiments, the building electrical system 102 is the combination of all local loads 122, local generators 124, and the ESS 126.

Loads are consumers of electrical energy within an electrical system. Examples of loads are air conditioning systems, motors, electric heaters, etc. The sum of the loads' electricity consumption rates can be measured in units of power (e.g., kW) and simply called “load” (e.g., a building load).

Generators may be devices, apparatuses, or other means for generating electrical energy within an electrical system. Examples are solar photovoltaic systems, wind generators, combined heat and power (CHP) systems, and diesel generators or “gen-sets.” The sum of electric energy generation rates of the generators 124 can be measured in units of power (e.g., kW) and simply referred to as “generation.”

As can be appreciated, loads may also generate at certain times. An example may be an elevator system that is capable of regenerative operation when the carriage travels down.

Unadjusted net power may refer herein to load minus generation in the absence of active control by a controller described herein. For example, if at a given moment a building has loads consuming 100 KW, and a solar photovoltaic system generating at 25 KW, the unadjusted net power is 75 KW. Similarly, if at a given moment a building has loads consuming 70 KW, and a solar photovoltaic system generating at 100 KW, the unadjusted net power is-30 KW. As a result, the unadjusted net power is positive when the load energy consumption exceeds generation, and negative when the generation exceeds the load energy consumption.

ESS power refers herein to a sum of a rate of electric energy consumption of an ESS. If ESS power is positive, an ESS is charging (consuming energy). If ESS power is negative, an ESS is generating (delivering energy).

Adjusted net power refers herein to unadjusted net power plus the power contribution of any controllable elements such as an ESS. Adjusted net power is therefore the net rate of consumption of electrical energy of the electrical system considering all loads, generators, and ESSs in the system, as controlled by a controller described herein.

Unadjusted demand is demand defined by the locally applicable tariff, but only based on the unadjusted net power. In other words, unadjusted demand does not consider the contribution of any ESS.

Adjusted demand or simply “demand” is demand as defined by the locally applicable tariff, based on the adjusted net power, which includes the contribution from any and all controllable elements such as ESSs. Adjusted demand is the demand that can be monitored by the utility and used in the demand charge calculation.

Referring again to FIG. 1, the building electrical system 102 may provide information to the controller 110, such as in a form of providing process variables. The process variables may provide information, or feedback, as to a status (e.g., a current state, condition, operating condition) of the building electrical system 102 and/or one or more components (e.g., loads 122, generators 124, ESSs 126) therein. For example, the process variables may provide one or more measurements of a state of the electrical system. The controller 110 receives the process variables for determining values for control variables to be communicated to the building electrical system 102 to effectuate a change to the building electrical system 102 toward meeting a controller objective for the building electrical system 102. For example, the controller 110 may provide a control variable to adjust the load 122, to increase or decrease generation by the generator 124, and to utilize (e.g., charge or discharge) the ESS 126. The controller 110 may also receive a configuration (e.g., a set of configuration elements), which may specify one or more constraints of the electrical system 102. The controller 110 may also receive external inputs (e.g., weather reports, changing tariffs, fuel costs, event data, probabilistic forecast of a utility peak), which may inform the determination of the values of the control variables. A set of external inputs may be received by the controller 110. The set of external inputs may provide indication of one or more conditions that are external to the controller 110 and the electrical system 102.

As noted, the controller 110 may attempt to meet certain objectives by changing a value associated with one or more control variables, if necessary. The objectives may be predefined, and may also be dependent on time, on any external inputs, on any process variables that are obtained from the building electrical system 102, and/or on the control variables themselves. Some examples of controller objectives for different applications are:
Minimize demand (KW) over a prescribed time interval;
Minimize demand charges ($) over a prescribed time interval;
Minimize total electricity charges ($) from the grid;
Reduce demand (KW) from the grid by a prescribed amount during a prescribed time window;
Maximize the life of the energy storage device;
Maximize utilization of the energy storage device battery over a target period of time; and
Obtain incentives from curtailing load for a system peak utility program.

Objectives can also be compound—that is, a controller objective can comprise multiple individual objectives. One example of a compound objective is to minimize demand charges while maximizing the life of the energy storage device. Other compound objectives including different combinations of the individual objectives are possible.

The inputs that the controller 110 may use to determine (or otherwise inform a determination of) the control variables can include configuration, external inputs, and process variables.

Process variables are typically measurements of the electrical system state and are used by the controller 110 to, among other things, determine how well its objectives are being met. These process variables may be read and used by the controller 110 to generate new control variable values. The rate at which process variables are read and used by the controller 110 depends upon the application but typically ranges from once per millisecond to once per hour. For battery ESS applications, the rate is often between 10 times per second and once per 15 minutes. Examples of process variables may include:
Unadjusted net power
Unadjusted demand
Adjusted net power
Demand
Load (e.g., load energy consumption for one or more loads)
Generation for one or more loads
Actual ESS charge or generation rate for one or more ESSs
Frequency
Energy storage device state of charge (SoC) (%) for one or more ESSs
Energy storage device temperature (deg. C.) for one or more ESSs
Electrical meter outputs such as kilowatt-hours (kWh) or demand
Battery degradation
Battery capacity loss
Battery age

A configuration received by the controller 110 (or input to the controller 110) may include or be received as one or more configuration elements (e.g., a set of configuration elements). The configuration elements may specify one or more constraints associated with operation of the electrical system 102. The configuration elements may define one or more cost elements associated with operation of the electrical system 102. Each configuration element may set a status, state, constant or other aspect of the operation of the electrical system 102. The configuration elements may be values that are typically constant during the operation of the controller 110 and the electrical system 102 at a particular location. The configuration elements may specify one or more constraints of the electrical system and/or specify one or more cost elements associated with operation of the electrical system.

Examples of configuration elements may include:
ESS type (for example, if a battery: states of charge, chemistry, manufacturer, and cell model)
ESS configuration (for example, if a battery: number of cells in series and parallel) and constraints (such as maximum charge and discharge powers)
ESS efficiency properties
ESS degradation properties (as a function of SoC, discharge or charge rate, and time).
Electricity supply tariff (including time of use supply rates and associated time windows)
Electricity demand tariff (including demand rates and associated time windows)
Electrical system constraints such as minimum power import
ESS constraints such as SoC limits or power limits (including maximum and minimum state of charge)
Historic data such as unadjusted net power or unadjusted demand, weather data, and occupancy
Operational constraints such as a requirement for an ESS to have a specified minimum amount of energy at a specified time of day
Goal ESS battery life (e.g., the desired lifespan of the battery)
Desired battery capacity at end of battery life

External inputs are variables that may be used by the controller 110 and that may change during operation of the controller 110. Examples are weather forecasts (e.g., irradiance for solar generation and wind speeds for wind generation) and event data (e.g., occupancy predictions). In some embodiments, tariffs (e.g., demand rates defined therein) may change during the operation of the controller 110, and may therefore be treated as an external input. An external input may also include a probabilistic forecast of a utility peak.

The outputs of the controller 110 are the control variables that can affect the electrical system behavior. Examples of control variables are:
ESS power command (kW or %). For example, an ESS power command of 50 KW would command the ESS to charge at a rate of 50 KW, and an ESS power command of −20 KW would command the ESS to discharge at a rate of 20 kW.
Building or subsystem net power increase or reduction (KW or %).
Renewable energy increase or curtailment (KW or %). For example, a photovoltaic (PV) system curtailment command of −100 KW would command a PV system to limit generation to no less than −100 KW. Again, the negative sign is indicative of the fact that the value is generative (non-consumptive).

In some embodiments, control variables that represent power levels may be signed, e.g., positive for consumptive or negative for generative.

In one illustrative example, consider that an objective of the controller 110 may be to reduce demand charges while preserving battery life. In this example, only the ESS may be controlled. To accomplish this objective, the controller 110 should have knowledge of a configuration of the electrical system 102, such as the demand rates and associated time windows, the battery capacity, the battery type and arrangement, etc. Other external inputs may also be used to help the controller 110 meet its objectives, such as a forecast of upcoming load and/or forecast of upcoming weather (e.g., temperature, expected solar irradiance, wind). Process variables from the electrical system 102 that may be used may provide information concerning a net electrical system power or energy consumption, demand, a battery SoC, an unadjusted building load, and an actual battery charge or discharge power.

In this one illustrative example, the control variable may be a commanded battery ESS's charge or discharge power. In order to more effectively meet the objective, the controller 110 may continuously track the peak net building demand (KW) over each applicable time window, and use the battery to charge or generate at appropriate times to limit the demand charges. In one specific example scenario, the ESS 126 may be utilized to attempt to achieve substantially flat (or constant) demand from the electrical utility distribution system 150 (e.g., the grid) during an applicable time window when a demand charge applies.

The controller 110, according to one embodiment of the present disclosure, can include an integrated global adjust (GA) module 160 or controller that may predict utility peaks and provide a probabilistic forecast to the controller 110. The probabilistic forecast may be used by or included in a cost function of the controller 110 and/or in evaluation of the cost function by the controller.

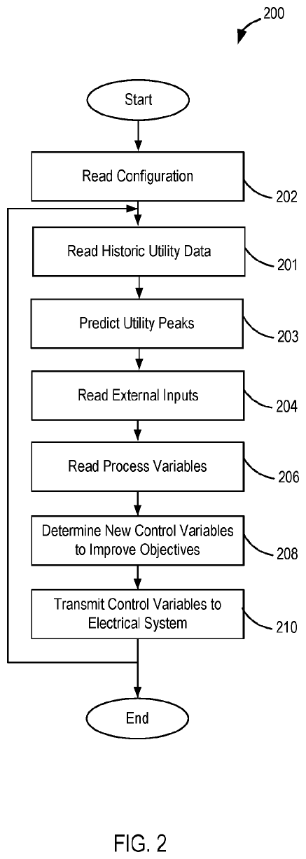

FIG. 2 is a flow diagram of a method 200 or process of controlling an electrical system, according to one embodiment of the present disclosure. The method 200 may be implemented by a controller of an electrical system, such as the controller 110 of FIG. 1 controlling the building electrical system 102 of FIG. 1. The controller may read 202 or otherwise receive a configuration (e.g., a set of configuration elements) of the electrical system.

The controller may also read historic utility data 201 including historic utility peaks. The controller may use the historic utility data 201 to predict future utility peaks 203 and generate a probabilistic forecast for utility peaks.

The controller may also read 204 or otherwise receive external inputs, such as weather reports (e.g., temperature, solar irradiance, wind speed), changing tariffs, event data (e.g., occupancy prediction, sizeable gathering of people at a location or venue), and the like.

The controller may also read 206 or otherwise receive process variables, which may be measurements of a state of the electrical system and indicate, among other things, how well objectives of the controller are being met. The process variables provide feedback to the controller as part of a feedback loop.

Using the configuration, the external inputs, predicted utility peaks, and/or the process variables, the controller determines 208 new control variables to improve achievement of objectives of the controller. Stated differently, the controller determines 208 new values for each control variable to effectuate a change to the electrical system toward meeting one or more controller objectives for the electrical system. Once determined, the control variables (or values thereof) are transmitted 210 to the electrical system or components of the electrical system. The transmission 210 of the control variables to the electrical system allows the electrical system to process the control variables to determine how to adjust and change state, which thereby can effectuate the objective(s) of the controller for the electrical system.

### Optimization

In some embodiments, the controller uses an algorithm (e.g., an optimization algorithm) to determine the control variables, for example, to improve performance of the electrical system. Optimization can be a process of finding a variable or variables at which a function f(x) is minimized or maximized. An optimization may be made with reference to such global extrema (e.g., global maximums and/or minimums), or even local extrema (e.g., local maximums and/or minimums). Given that an algorithm that finds a minimum of a function can generally also find a maximum of the same function by negating it, this disclosure will sometimes use the terms “minimization,” “maximization,” and “optimization” interchangeably.

An objective of optimization may be economic optimization, or determining economically optimal control variables to effectuate one or more changes to the electrical system to achieve economic efficiency (e.g., to operate the electrical system at as low a cost as may be possible, given the circumstances). As can be appreciated, other objectives may be possible as well (e.g., regarding equipment life, system reliability, system availability, fuel consumption, etc.).

The present disclosure includes embodiments of controllers that optimize a single parameterized cost function (or objective function) for effectively utilizing controllable components of an electrical system in an economically optimized manner. Various forms of optimization may be utilized to economically optimize an electrical system.

### Continuous Optimization

A controller according to some embodiments of the present disclosure may use continuous optimization to determine the control variables. More specifically, the controller may utilize a continuous optimization algorithm, for example, to find economically optimal control variables to effectuate one or more changes to the electrical system to achieve economic efficiency (e.g., to operate the electrical system at as low a cost as may be possible, given the circumstances). The controller, in one embodiment, may operate on a single objective: optimize overall system economics. Since this approach has only one objective, there can be no conflict between objectives. And by specifying system economics appropriately in the cost function (or objective function), all objectives and value streams can be considered simultaneously based on their relative impact on a single value metric. The cost function may be continuous in its independent variables x, and optimization can be executed with a continuous optimization algorithm that is effective for continuous functions. Continuous optimization differs from discrete optimization, which involves finding the optimum value from a finite set of possible values or from a finite set of functions.

As can be appreciated, in another embodiment, the cost function may be discontinuous in x (e.g., discrete or finite) or piecewise continuous in x, and optimization can be executed with an optimization algorithm that is effective for discontinuous or piecewise continuous functions.

### Constrained Optimization

In some embodiments, the controller utilizes a constrained optimization to determine the control variables. In certain embodiments, the controller may utilize a constrained continuous optimization to find a variable or variables xₒₚₜ at which a continuous function f(x) is minimized or maximized subject to constraints on the allowable x.

### Generalized Optimization

A controller according to some embodiments of the present disclosure may use generalized optimization to determine the control variables. More specifically, the controller may utilize a generalized optimization algorithm, for example, to find economically optimal control variables to effectuate one or more changes to the electrical system to achieve economic efficiency (e.g., to operate the electrical system at as low a cost as may be possible, given the circumstances).

An algorithm that can perform optimization for an arbitrary or general real function f(x) of any form may be called a generalized optimization algorithm. An algorithm that can perform optimization for a general continuous real function f(x) of a wide range of possible forms may be called a generalized continuous optimization algorithm. Some generalized optimization algorithms may be able to find optimums for functions that may not be continuous everywhere, or may not be differentiable everywhere. Some generalized optimization algorithms are available as pre-written software in many languages including Java®, C++, and MATLAB®. They often use established and well-documented iterative approaches to find a function's minimum.

As can be appreciated, a generalized optimization algorithm may also account for constraints, and therefore be a generalized constrained optimization algorithm.

### Nonlinear Optimization

A controller according to some embodiments of the present disclosure may use nonlinear optimization to determine the control variables. More specifically, the controller may utilize a nonlinear optimization algorithm, for example, to find economically optimal control variables to effectuate one or more changes to the electrical system to achieve economic efficiency (e.g., to operate the electrical system at as low a cost as may be possible, given the circumstances).

Nonlinear continuous optimization or nonlinear programming is similar to generalized continuous optimization and describes methods for optimizing continuous functions that may be nonlinear, or where the constraints may be nonlinear.

### Multivariable Optimization

A controller according to some embodiments of the present disclosure may use multivariable optimization to determine the control variables. More specifically, the controller may utilize a multivariable optimization algorithm, for example, to find economically optimal control variables to effectuate one or more changes to the electrical system to achieve economic efficiency (e.g., to operate the electrical system at as low a cost as may be possible, given the circumstances).

For example, the equation

$$f ( x ) = 100 {( {x}_{2} - {x}_{1}^{2} )}^{2} + {( 1 - {x}_{1} )}^{2}$$

is a multivariable equation. In other words, x is a set composed of more than one element. Therefore, the optimization algorithm is “multivariable.” A subclass of optimization algorithms is the multivariable optimization algorithm that can find the minimum of f (x) when x has more than one element.

### Economically Optimizing Electrical System Controller

A controller, according to one embodiment of the present disclosure, will now be described to provide an example of using optimization to control an electrical system. An objective of using optimization may be to minimize the total electrical system operating cost during a period of time. For example, the approach of the controller may be to minimize the operating cost during an upcoming time domain, or future time domain, which may extend from the present time by some number of hours (e.g., integer numbers of hours, fractions of hours, or combinations thereof). As another example, the upcoming time domain, or future time domain, may extend from a future time by some number of hours. Costs included in the total electrical system operating cost may include electricity supply charges, electricity demand charges, a battery degradation cost, equipment degradation cost, efficiency losses, etc. Benefits, such as incentive payments including system peak utility programs, which may reduce the electrical system operating cost, may be incorporated (e.g., as negative numbers or values) or otherwise considered. Other costs may be associated with a change in energy in the ESS such that adding energy between the beginning and the end of the future time domain is valued. Other costs may be related to reserve energy in an ESS such as for backup power purposes. All of the costs and benefits can be summed into a net cost function, which may be referred to as simply the “cost function.”

In certain embodiments, a control parameter set X can be defined (in conjunction with a control law) that is to be applied to the electrical system, how the electrical system should behave, and at what times in the future time domain they should be applied. In some embodiments, the cost function can be evaluated by performing a simulation of electrical system operation with a provided set X of control parameters. The control laws specify how to use X and the process variables to determine the control variables. The cost function can then be prepared or otherwise developed to consider the control parameter set X.

For example, a cost fc (X) may consider the control parameter values in X and return the scalar net cost of operating the electrical system with those control parameter values. All or part of the control parameter set X can be treated as a variable set Xₓ (e.g., x as described above) in an optimization problem. The remaining part of X, X_{logic}, may be determined by other means such as logic (for example logic based on constraints, inputs, other control parameters, mathematical formulas, etc.). Any constraints involving Xₓ can be defined, if so desired. Then, an optimization algorithm can be executed to solve for the optimal Xₓ. We can denote Xₒₚₜ as the combined Xₓ and X_{logic} values that minimize the cost function subject to the constraints, if any. Since Xₒₚₜ represents the control parameters, this example process fully specifies the control that will provide minimum cost (e.g., optimal) operation during the future time domain. Furthermore, to the limits of computing capability, this optimization can consider the continuous domain of possible Xₓ values, not just a finite set of discrete possibilities. This example method continuously can “tune” possible control sets until an optimal set is found. As shorthand notation, we may refer to these certain example embodiments as an economically optimizing electrical system controller (EOESC).

Some of the many advantages of using an EOESC, according to certain embodiments, compared to other electrical system controllers are significant:
1) Any number of value streams may be represented in the cost function, giving the EOESC an ability to optimize on all possible value streams and costs simultaneously. As an example, generalized continuous optimization can be used to effectively determine the best control given both time of use (ToU) supply charge reduction and demand charge reduction simultaneously, all while still considering battery degradation cost.
2) With a sufficiently robust optimization algorithm, only the cost function, control law, and control parameter definitions need be developed. Once these three components are developed, they can be relatively easily maintained and expanded upon.
3) An EOESC can yield a true economically optimum control solution to machine or processor precision limited only by the cost function, control laws, and control parameter definitions.
4) An EOESC may yield not only a control to be applied at the present time, but also the planned sequence of future controls. This means one execution of an EOESC can generate a lasting set of controls that can be used into the future, rather than a single control to be applied at the present. This can be useful in case a) the optimization algorithm takes a significant amount of time to execute, or b) there is a communication interruption between the processor calculating the control parameter values and the processor interpreting the control parameters and sending control variables to the electrical system.

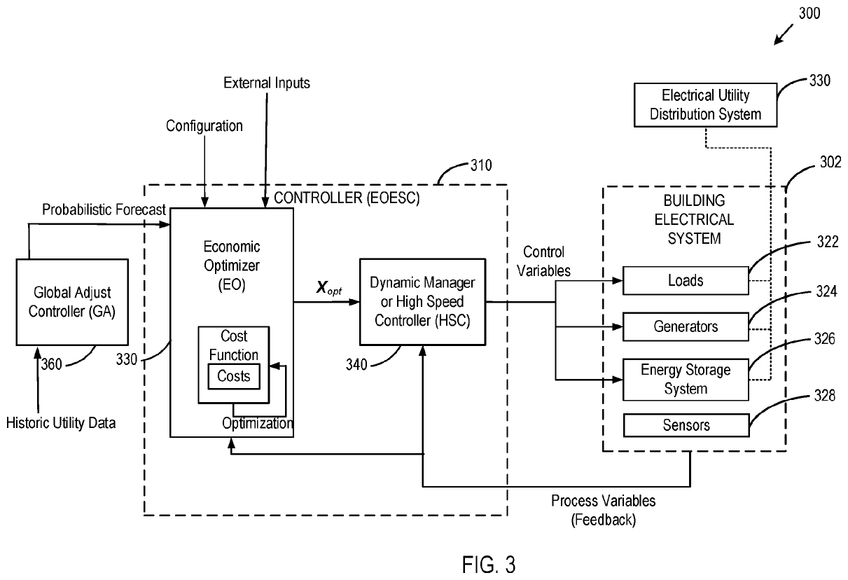

FIG. 3 is a control diagram of an electrical system 300, according to one embodiment of the present disclosure, including an EOESC 310 and a global adjust controller (GA) 360. Stated otherwise, FIG. 3 is a diagram of a system architecture of the electrical system 300 including the EOESC 310 and the GA 360, according to one embodiment. The EOESC 310 may optimize the electrical system 300 according to short-term objectives using an optimization algorithm. The GA 360 may predict utility peaks and provide a probabilistic forecast to the EOESC 310. In some embodiments, the GA 360 provides the probabilistic forecast to multiple EOESCs. In the embodiment of FIG. 3, the GA 360 is distinct from the EOESC 310, and may be in communication via a wired or wireless network. In other embodiments, the GA 360 may be integrated into a controller, such as in the controller 110 of FIG. 1.

The electrical system 300 comprises a building electrical system 302 that is controlled by the EOESC 310. The building electrical system 302 includes one or more loads 322, one or more generators 324, an energy storage system (ESS) 326, and one or more sensors 328 (e.g., meters) to provide measurements or other indication(s) of a state of the building electrical system 302. The building electrical system 302 is coupled to an electrical utility distribution system 350, and therefore may be considered on-grid. Similar diagrams can be drawn for other applications such as a photovoltaic generator plant and an off-grid building.

The EOESC 310 receives or otherwise obtains a configuration of the electrical system, external inputs, and process variables and produces control variables to be sent to the electrical system 302 to effectuate a change to the electrical system toward meeting a short-term controller objective for economical optimization of the electrical system, for example during an upcoming time domain. For example, the EOESC 310 may attempt to reduce demand of the electrical system 300 over a time segment of an upcoming time domain.

The EOESC 310 may include electronic hardware and software to process the inputs (e.g., the configuration of the electrical system, external inputs, and process variables) to determine values for each of the control variables. The EOESC 310 may include one or more processors and suitable storage media, which store programming in the form of executable instructions which are executed by the processors to implement the control processes.

In the embodiment of FIG. 3, the EOESC 310 includes an economic optimizer (EO) 330 and a dynamic manager (or high speed controller (HSC)) 340. The EO 330 according to some embodiments is presumed to have the ability to measure or obtain a current date and time. The EO 330 may determine a set of values for a control parameter set X and provide the set of values and/or the control parameter set X to the HSC 340. The EO 330 may use a generalized optimization algorithm to determine an optimal set of values for the control parameter set Xₒₚₜ. The HSC 340 utilizes the set of values for the control parameter set X (e.g., an optimal control parameter set Xₒₚₜ) to determine the control variables to communicate to the electrical system 302. The HSC 340 in some embodiments is also presumed to have the ability to measure or obtain a current date and time. The two-part approach of the EOESC 310, namely the EO 330 determining control parameters and then the HSC 340 determining the control variables, enables generation of a lasting set of controls, or a control solution (or plan) that can be used into the future rather than a single control to be applied at the present. Preparing a lasting control solution can be useful if the optimization algorithm takes a significant amount of time to execute. Preparing a lasting control solution can also be useful if there is a communication interruption between the calculating of the control parameter values and the processor interpreting the control parameters and sending control variables to the electrical system 302. The two-part approach of the EOESC 310 also enables the EO 330 to be disposed or positioned at a different location from the HSC 340. In this way, intensive computing operations that optimization may require can be performed by resources with higher processing capability that may be located remote from the building electrical system 302. These intensive computing operations may be performed, for example, at a data center or server center (e.g., in the cloud).

As can be appreciated, the EOESC 310 of FIG. 3 may be arranged and configured differently than shown in FIG. 3, in other embodiments. For example, instead of the EO 330 passing the control parameter set Xₒₚₜ (the full set of control parameters found by a generalized optimization algorithm of the EO 330) to the HSC 340, the EO 330 can pass a subset of Xₒₚₜ to the HSC 340. Similarly, the EO 330 can pass Xₒₚₜ and additional control parameters to the HSC 340 that are not contained in Xₒₚₜ. Likewise, the EO 330 can pass modified elements of Xₒₚₜ to the HSC 340. In one embodiment, the EO 330 finds a subset Xₓ of the optimal X, but then determines additional control parameters X_{logic}, and passes X_{logic} together with Xₓ to the HSC 340. In other words, in this example, the Xₓ values are to be determined through an optimization process of the EO 330 and the X_{logic} values can be determined from logic. An objective of the EO 330 is to determine the values for each control parameter whether using optimization and/or logic.

For brevity in this disclosure, keeping in mind embodiments where X comprises independent (Xₓ) parameters and dependent (X_{logic}) parameters, when describing optimization of a cost function versus X, what is meant is variation of the independent variables Xₓ until an optimum (e.g., minimum) cost function value is determined (within a threshold). In this case, the resulting Xₒₚₜ will consist of the combined optimum Xₓ parameters and associated X_{logic} parameters.

The GA 360 may predict utility peaks and provide a probabilistic forecast to the EOESC 310. Thus, instead of predicting peaks for the site as the EOESC 310 does, the GA 360 may forecast peaks for a utility or ISO. The probabilistic forecast may be used by the cost function of the EOESC 310. For example, the incentive for a predicted utility peak may be considered when determining the cost.

The probabilistic forecast may comprise a prediction of future utility peaks. The GA 360 may include a communication interface to receive historic utility data. The historic utility data may include historic utility peak data. The historic utility data may be used to predict future utility peaks. To forecast the utility peaks, some embodiments may forecast whether a given day will possibly include a utility peak (i.e., a candidate utility peak period) and forecast peak hours of the candidate utility peak period.

In one embodiment, the GA 360, the EOESC 310, and one or more of their components are executed as software or firmware (for example stored on non-transitory media, such as appropriate memory) by one or more processors. For example, the EO 330 may comprise one or more processors to process the inputs and generate the set of values for the control parameter set X. Similarly, the HSC 340 may comprise one or more processors to process the control parameter set X and the process variables and generate the control variables. Similarly, the GA 360 may comprise one or more processors to process the adjustment factor. The processors may be computers, microcontrollers, CPUs, logic devices, or any other digital or analog device that can operate on pre-programmed instructions. If more than one processor is used, they can be connected electrically, wirelessly, or optically to pass signals between one another. In addition, the control variables can be communicated to the electrical system components electrically, wirelessly, or optically or by any other means. The processor has the ability to store or remember values, arrays, and matrices, which can be viewed as multi-dimensional arrays, in some embodiments. This storage may be performed using one or more memory devices, such as read access memory (RAM), disk drives, etc.

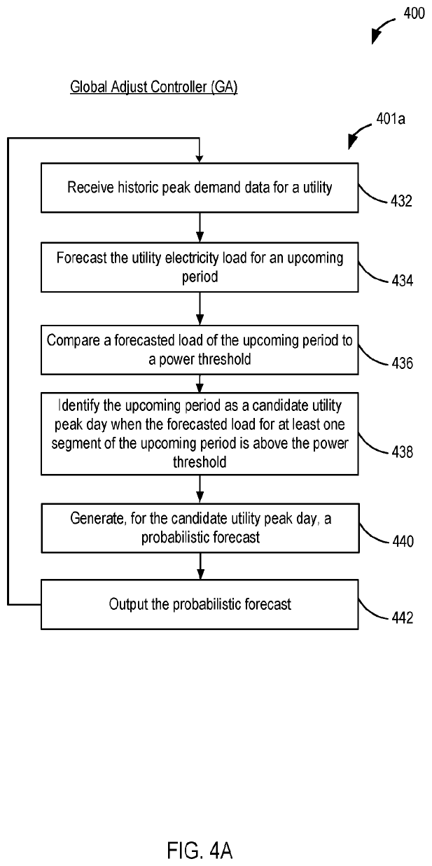

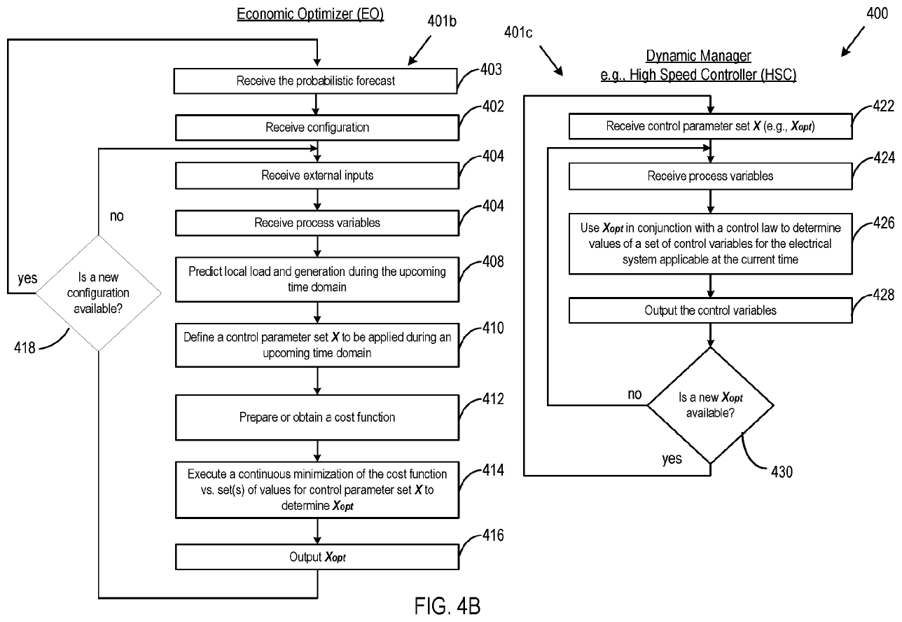

FIGS. 4A-4B illustrate flow diagrams of a method 400 or process of controlling an electrical system based on a predicted utility peak, according to one embodiment of the present disclosure.

The method 400 includes three separate processes, namely a global adjust controller (GA) process 401a (FIG. 4A), an economic optimizer (EO) process 401b (FIG. 4B), and a high speed controller (HSC) process 401c (FIG. 4B).

FIG. 4A illustrates a flow diagram of an GA process 401a. The GA process 401a of FIG. 4A may execute separate from, or even independent from the EO process 401a (FIG. 4B) and the HSC process 401c (FIG. 4B). Because the GA process 401a can run separate and distinct from the EO process 401b (FIG. 4B) and the HSC process 401c (FIG. 4B), the execution of these processes 401b, 401c, 401a may be collocated on a single system or isolated on remote systems. Additionally, how frequently each process runs may be independent. For example, the GA process 401a can perform its operations less frequently than the EO process 401b (FIG. 4B) and the HSC process 401c (FIG. 4B).

The GA process 401a may be a computer-implemented process executed by one or more computing devices, such as the GA 360 of FIG. 3. The GA may receive 432 and store historic peak demand data for a utility. The historic peak demand data information related to past peaks of electrical load for the utility. The GA may forecast 434 a utility electricity load for an upcoming period. The GA may use a machine learning neural network regression algorithm to forecast the utility electricity load.

The GA may predict when an electricity load peak of the utility may occur. In some embodiments, the prediction may include two steps, one step for predicting whether a given day is a candidate system peak day and one step to forecast peak hours. To predict a utility electricity load peak, the GA may compare 436 a forecasted load of the upcoming period to a power threshold and identify 438 the upcoming period as a candidate utility peak period (e.g., candidate utility peak day) when the forecasted load for at least one segment of the upcoming period is above a power threshold. The upcoming period may be 24 hours and each of the segments may be an hour. The candidate utility peak period may be a day in which it is possible a utility electricity peak segment could occur.

In some embodiments, segments of the upcoming period may be compared to the power threshold to identify the upcoming period as a candidate utility peak period. For example, the forecasted load for each segment may be compared to the power threshold to identify the upcoming period as the candidate utility peak period. In some embodiments, a minimum of the forecasted load may be compared to the power threshold to identify the upcoming period as the candidate utility peak period. In some embodiments, a maximum of the forecasted load is compared to the power threshold to identify the upcoming period as the candidate utility peak period. In some embodiments, an hourly average of the forecasted load is compared to the power threshold to identify the upcoming period of the as the candidate utility peak period.

The power threshold may be based on historic peaks in the utility load. For example, in some embodiments, the power threshold may be an average of a set of latest historical utility peaks. In some embodiments, the power threshold may be a weighted average of a set of latest historical utility peaks, such that more recent utility peaks are considered more relevant and thereby handled as such. In other embodiments, the power threshold may be a minimum of a set of latest historical utility peaks. In yet other embodiments, the power threshold may be a minimum of a set of utility peaks that happened during a previous year.

The GA may generate 440, for the candidate utility peak period, a probabilistic forecast. To generate the probabilistic forecast, the GA may forecast peak segments of the upcoming period using a machine learning classification model. The probabilistic forecast may be updated throughout the upcoming time period. For example, the GA may update the probabilistic forecast every fifteen-minute interval of a candidate system peak day

The probabilistic forecast may include probabilities for segments of the upcoming period indicating potential of the utility electricity peak occurring during a specified segment. In some embodiments, the number of segments and associated probabilities in the probabilistic forecast is correlated to the energy size and inverter power of an ESS of the electrical system. In some embodiments, the GA process 401a may further include renormalizing the probabilities in the probabilistic forecast based on how many segments and associated probabilities are in the probabilistic. In some embodiments, the GA may pad probabilities for one or more segments before a predicted utility electricity peak and one or more segments after the predicted utility electricity peak.

The GA may output 442 the probabilistic forecast. For example, the GA may provide, via a communication interface, the probabilistic forecast to one or more EOs. As shown in FIG. 4B, the probabilistic forecast may be used as a parameter for a cost function to determine one or more parameters to effectuate a change to the electrical system to attempt to participate in a system peak utility program.

FIG. 4B illustrates a flow diagram of an EO process 401b, and an HSC process 401c of the method 400 or process of controlling an electrical system of FIG. 4A. The HSC process 401c may also be referred to herein as a dynamic manager process 401c. The HSC process 401c may utilize a control parameter set X determined by the EO process 401b. Nevertheless, the HSC process 401c may execute separate from, or even independent from, the EO process 401b, based on a control parameter set X determined at an earlier time by the EO process 401b. Because the EO process 401b can run separate and distinct from the HSC process 401c, the execution of these processes 401b, 401c may be collocated on a single system or isolated on remote systems.

The EO process 401b may be a computer-implemented process executed by one or more computing devices, such as the EO 330 of FIG. 3. The EO process 401b may receive 403 a probabilistic forecast from the GA process 401a. The probabilistic forecast may provide probabilities of a peak in utility demand. The probabilistic forecast may be used as, incorporated into, or otherwise included as part of a cost function. The EO process 401b may receive 402 a configuration, or a set of configuration elements, of the electrical system. The configuration may specify one or more constraints of the electrical system. The configuration may specify one or more constants of the electrical system. The configuration may specify one or more cost elements associated with operation of the electrical system. The cost elements may include one or more of an electricity cost (e.g., an electricity supply charge, an electricity demand charge), a battery degradation cost, an equipment degradation cost, a tariff definition (e.g., an electricity supply tariff providing ToU supply rates and associated time windows, or an electricity demand tariff providing demand rates and associated time windows), a cost of local generation, penalties associated with deviation from an operating plan (e.g., a prescribed operating plan, a contracted operating plan), costs or benefits associated with a change in energy in the ESS such that adding energy between the beginning and the end of the future time domain is valued, costs or benefits (e.g., a payment) for contracted maneuvers, costs or benefits associated with a system peak utility program, costs or benefits associated with the amount of energy stored in an ESS as a function of time, and a value of comfort that may be a function of other process variables such as building temperature.

In certain embodiments, the set of configuration elements define the one or more cost elements by specifying how to calculate an amount for each of the one or more cost elements. For example, the definition of a cost element may include a formula for calculating the cost element.

In certain embodiments, the cost elements specified by the configuration elements may include one or more incentives associated with operation of the electrical system. An incentive may be considered as a negative cost. The one or more incentives may include one or more of an incentive revenue, a demand response revenue, a system peak utility program revenue, a value of reserve energy or battery capacity (e.g., for backup power as a function of time), a contracted maneuver, revenue for demand response opportunities, revenue for ancillary services, and revenue associated with deviation from an operating plan (e.g., a prescribed operating plan, a contracted operating plan).

In other embodiments, the configuration elements may specify how to calculate an amount for one or more of the cost elements. For example, a formula may be provided that indicates how to calculate a given cost element.

External inputs may also be received 404. The external inputs may provide indication of one or more conditions that are external to the controller and/or the electrical system. For example, the external inputs may provide indication of the temperature, weather conditions (e.g., patterns, forecasts), and the like.

Process variables are received 406. The process variables provide one or more measurements of a current state of the electrical system. The set of process variables can be used to determine progress toward meeting an objective for economical optimization of the electrical system. The process variables may be feedback in a control loop for controlling the electrical system.

The EO process 401b may include predicting 408 a local load and/or generation during an upcoming time domain. The predicted local load and/or local generation may be stored for later consideration. For example, the predicted load and/or generation may be used in a later process of evaluating the cost function during a minimization of the cost function.

A control parameter set X may be defined 410 to be applied during an upcoming time domain. In defining the control parameter set X, the meaning of each element of X is established. A first aspect in defining 410 the control parameter set X may include selecting a control law. Then, for example, X may be defined 410 as a matrix of values such that each column of X represents a set of control parameters for the selected control law to be applied during a particular time segment of the future time domain. In this example, the rows of X represent individual control parameters to be used by the control law. Further to this example, the first row of X can represent the nominal ESS power during a specific time segment of the future time domain. Likewise, X may be further defined such that the second row of X is the maximum demand limit (e.g., a maximum demand setpoint). A second aspect in defining 410 may include splitting the upcoming time domain into sensible segments and selecting the meaning of the control parameters to use during each segment. The upcoming future time domain may be split into different numbers of segments depending on what events are coming up during the future time domain. For example, if there are no supply charges and there is only one demand period, the upcoming time domain may be split into a few segments. The few segments may correlate to before the demand period, during the demand period, and after the demand period. But if there is a complicated scenario with many changing rates and constraints, the upcoming time domain may be split into many segments. Lastly, in defining 410 the control parameters X, some control parameters Xₓ may be marked for determination using optimization, and others X_{logic} may be marked for determination using logic (for example, logic based on constraints, inputs, other control parameters, mathematical formulas, etc.).

The EO process 401b may also prepare 412 or obtain a cost function. Preparing 412 the cost function may be optional and can increase execution efficiency by pre-calculating certain values that will be needed each time the cost function is evaluated. The cost function may be prepared 412 (or configured) to include or account for any constraints on the electrical system. The cost function can include the probabilistic forecast from the GA to account for potential revenue from a system peak utility program.

With the control parameter set X defined 410 and the cost function prepared 412, the EO process 401b can execute 414 a minimization or optimization of the cost function resulting in the optimal control parameter set Xₒₚₜ. For example, a continuous optimization algorithm may be used to identify an optimal set of values for the control parameter set Xₒₚₜ (e.g., to minimize the cost function) in accordance with the one or more constraints and the one or more cost elements. The continuous optimization algorithm may be one of many types. For example, it may be a generalized continuous optimization algorithm. The continuous optimization algorithm may be a multivariable continuous optimization algorithm. The continuous optimization algorithm may be a constrained continuous optimization algorithm. The continuous optimization algorithm may be a Newton-type algorithm. It may be a stochastic-type algorithm such as Covariance Matrix Adaption Evolution Strategy (CMAES). Other algorithms that can be used are BOBYQA (Bound Optimization by Quadratic Approximation) and COBYLA (Constrained Optimization by Linear Approximation).

To execute the optimization of the cost function, the cost function may be evaluated many times. Each time, the evaluation may include performing a simulation of the electrical system operating during the future time domain with a provided control parameter set X, and then calculating the cost associated with that resulting simulated operation. The cost function may include or otherwise account for the one or more cost elements received 402 in the configuration. For example, the cost function may be a summation of the one or more cost elements (including any negative costs, such as incentive, revenues, and the like). In this example, the optimization step 414 would find Xₒₚₜ that minimizes the cost function. The cost function may also include or otherwise account for the one or more constraints on the electrical system. The cost function may include or otherwise account for any values associated with the electrical system that may be received 402 in the configuration.

The cost function may also evaluate another economic metric such as payback period, internal rate of return (IRR), return on investment (ROI), net present value (NPV), or carbon emission. In these examples, the function to minimize or maximize would be more appropriately termed an “objective function.” In case the objective function represents a value that should be maximized, such as IRR, ROI, or NPV, the optimizer should be set up to maximize the objective function when executing 414, or the objective function could be multiplied by −1 before minimization. Therefore, as can be appreciated, elsewhere in this disclosure, “minimizing” the “cost function” may also be more generally considered for other embodiments as “optimizing” an “objective function.”

The continuous optimization algorithm may execute the cost function (e.g., simulate the upcoming time domain) a plurality of times with various parameter sets X to identify an optimal set of values for the control parameter set Xₒₚₜ to minimize the cost function. The cost function may include a summation of the one or more cost elements, and evaluating the cost function may include returning a summation of the one or more cost elements incurred during the simulated operation of the control system over the upcoming time domain.

The optimal control parameter set Xₒₚₜ is then output 416. In some embodiments, the output 416 of the optimal control parameter set Xₒₚₜ may be stored locally, such as to memory, storage, circuitry, and/or a processor disposed local to the EO process 401b. In some embodiments, the outputting 416 may include transmission of the optimal control parameter set Xₒₚₜ over a communication network to a remote computing device.

The EO process 401b repeats for a next upcoming time domain (a new upcoming time domain). A determination 418 is made whether a new configuration is available. If yes, then the EO process 401b receives 402 the new configuration and determines if there is a new probabilistic forecast. If no, then the EO process 401b may skip receiving 402 the configuration and simply receive 404 the external inputs.

As can be appreciated, in other embodiments an EO process may be configured differently, to perform operations in a differing order, or to perform additional and/or different operations. In certain embodiments, an EO process may determine values for a set of control variables to provide to the electrical system to effectuate a change to the electrical system toward meeting the controller objective for economical optimization of the electrical system during an upcoming time domain, rather than determining values for a set of control parameters to be communicated to an HSC process. The EO process may provide the control variables directly to the electrical system, or to an HSC process for timely communication to the electrical system at, before, or during the upcoming time domain.

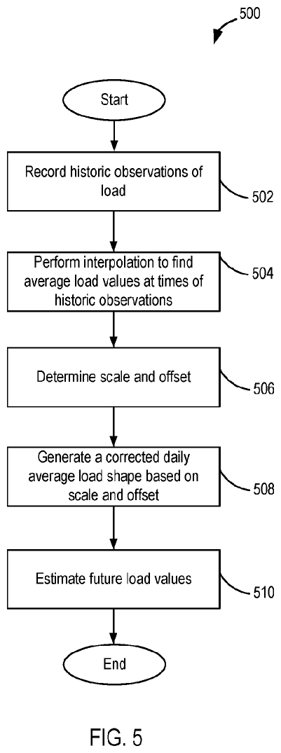

The HSC process 401c may be a computer-implemented process executed by one or more computing devices, such as the HSC 540 of FIG. 5. The HSC process 401c may receive 422 a control parameter set X, such as the optimal control parameter set Xₒₚₜ output 416 by the EO process 401b. Process variables are also received 424 from the electrical system. The process variables include information, or feedback, about a status (e.g., a current state, condition, or operating condition) of the electrical system and/or one or more components therein.

The HSC process 401c determines 426 values for a set of control variables for controlling one or more components of the electrical system at the current time. The HSC process 401c determines 426 the values for the control variables by using the optimal control parameter set Xₒₚₜ in conjunction with a control law. The control laws specify how to determine the control variables from X (or Xₒₚₜ) and the process variables. Stated another way, the control law enforces the definition of X. For example, for a control parameter set X defined such that a particular element, Xᵢ, is an upper bound on demand to be applied at the present time, the control law may compare process variables such as the unadjusted demand to Xᵢ. If unadjusted building demand exceeds Xᵢ, the control law may respond with a command (in the form of a control variable) to instruct the ESS to discharge at a rate that will make the adjusted demand equal to or less than Xᵢ.

The control variables (including any newly determined values) are then output 428 from the HSC process 401c. The control variables are communicated to the electrical system and/or one or more components therein. Outputting 428 the control variables may include timely delivery of the control variables to the electrical system at, before, or during the upcoming time domain and/or applicable time segment thereof. The timely delivery of the control variables may include an objective to effectuate a desired change or adjustment to the electrical system during the upcoming time domain.

A determination 430 is then made whether a new control parameter set X (and/or values thereof) is available. If yes, then the new control parameter set X (or simply the values thereof) is received 422 and HSC process 401c repeats. If no, then the HSC process 401c repeats without receiving 422 a new control parameter set X, such as a new optimal control parameter set Xₒₚₜ.

As can be appreciated, in other embodiments an HSC process may be configured differently, to perform operations in a differing order, or to perform additional and/or different operations. For example, in certain embodiments, an HSC process may simply receive values for the set of control variables and coordinate timely delivery of appropriate control variables to effectuate a change to the electrical system at a corresponding time segment of the upcoming time domain.

The example embodiment of an EOESC 310 in FIG. 3 and a control method 400 in FIGS. 4A-4B illustrate a two-piece or staged controller, which splits a control problem into two pieces (e.g., a low speed optimizer and a high speed dynamic manager (or high speed controller (HSC)). Nevertheless, as can be appreciated, in certain embodiments a single-stage approach to a control problem may be utilized to determine optimal control values to command an electrical system.

### Economic Optimizer (EO)

Greater detail will now be provided about some elements of an EO, according to some embodiments of the present disclosure.

### Predicting a Load/Generation of an Upcoming Time Domain

In many electrical system control applications, a load of the electrical system (e.g., a building load) changes over time. Load can be measured as power or as energy change over some specified time period, and is often measured in units of kW. As noted above with reference to FIG. 4B, an EO process 401b may predict 408 a local load and/or generation during an upcoming time domain. The prediction may be performed using various techniques. For example, the EO process 401b may predict 408 a local load and/or generation during an upcoming time domain by scaling and offsetting historic values, simulating loads and generation, using a Kalman filter, using stochastic prediction, or performing iterative and recursive signal processing methods. FIG. 58 illustrates one example embodiment of how, an EO process 401b may predict 408 a local load and/or generation during an upcoming time domain.

FIG. 5 is a flow diagram of a method 500 of predicting load and/or generation of an electrical system during an upcoming time domain, according to one embodiment. A controller, according to some embodiments of the present disclosure, may have the ability to predict the changing load that may be realized during an upcoming time domain. These load and generation predictions may be used when the cost function is evaluated. To account for and reap a benefit from some types of value streams such as demand charge reduction, an accurate estimate of the upcoming load can be important. An accurate projection of a load during an upcoming time domain enables an EO to make better control decisions to capitalize on value streams such as demand charge reduction.

A method of predicting load, according to one embodiment of the present disclosure, may perform a load prediction considering historic periodic trends or shapes such as a daily trend or shape. The load prediction can execute every time an EO executes an EO process, or it can execute more or less frequently. The load prediction may be executed by performing a regression of a parameterized historic load shape against historic load data (typically less than or equal to 24 hours) in one embodiment. Regression algorithms such as least squares may be used. A compilation of historic trends may be recorded as a historic average (or typical) profile or an average load shape. The historic average profile or average load shape may be a daily (24-hour) historic average profile that represents a typical day. The compilation of historic observations and/or historic average profile may be received from another system, or may be gathered and compiled (or learned) as part of the method of predicting load, as will be explained below with reference to FIG. 5.

Referring to FIG. 5, historic observations of load are recorded 502. For example, the last h hours of historic observations of load may be continuously recorded and stored in memory, each measurement having a corresponding time of day at which time it was measured in an array pair historic_load_observed and historic_load_observed_time_of_day. The last h hours can be any amount of time, but in one embodiment, it is between 3 and 18 hours.

Assume for now that a daily average load shape array or vector is in memory named avg_load_shape, with a corresponding array avg_load_shape_time_of_day of the same length. The avg_load_shape and avg_load_shape_time_of_day represent a historic average profile and/or historic trends. The time domain of avg_load_shape_time_of_day is 24 hours, and the time interval of discretization of avg_load_shape_time_of_day could be any value. Between 5 and 120 minutes may be used, depending on the application, in some embodiments. As an example, if the interval of discretization is chosen to be 30 minutes, there will be 48 values comprising avg_load_shape and 48 values comprising avg_load_shape_time_of_day.

An interpolation is performed 504 to find the avg_load_shape values at each of the times in historic_load_observed_time_of_day. Call this new interpolated array avg_load_shape_interpolated. Consider mathematically avg_load_shape_interpolated with a scale and offset defined as: average_load_shape_interpolated_p=avg_load_shape_interpolated*scale+offset. In some embodiments, the interpolation is a linear interpolation. In other embodiments, the interpolation is a nonlinear interpolation.

A scale and offset are determined 506. For example, the method 500 may perform a least squares regression to determine 506 scale and offset that minimize the sum of the squares of the error between average_load_shape_interpolated_p and historic_load_observed. Call these resulting scale and offset values scale_fit and offset_fit. In some embodiments, the determining 506 of scale and offset can utilize weighted least squares techniques that favor more recent observations.

A corrected daily average load shape is generated 508 based on the scale and/or offset. For example, a corrected load shape may be generated 508 for a full day as avg_load_shape_fit=avg_load_shape*scale_fit+offset_fit.

The future load values can then be estimated 510, such as by interpolating. A future load value at any time of day in the future time domain can now be estimated by interpolating 504 to that time of day from the pair of arrays avg_load_shape_fit and avg_load_shape_time_of_day.

The method of FIG. 5 describes one embodiment of a method for predicting load. If a local generator is present in an electrical system, the same or a similar method can be applied for predicting generation. Instead of a “load shape,” a “generation shape” can be stored in memory. For generators where the generation is known at a particular time (such as a photovoltaic generator which would be expected to have nearly zero generation at nighttime), the prediction and generation shape can be constrained to specific values at specific times of the day. In this case, instead of using regression to determine both scale and offset, perhaps only scale may be needed.

Another aspect of this embodiment of a method to predict load and/or generation is the ability to incorporate external inputs to modify the prediction of load or generation. In one embodiment, the prediction is made as already described, then the prediction is modified with the use of external information such as a weather forecast or building occupancy forecast.

By having a pre-determined differential relationship for load (or generation) versus input data, the prediction can be modified in one example as follows:
1) An external input is read which contains a forecasted variable x_{input,forecast}.
2) From configuration information, a value of the differential

$${[ \frac{d ( load )}{d ( {x}_{input} )} ]}_{{x}_{n o m}}$$

is available which is valid near some nominal xᵢₙₚᵤₜ value of xₙₒₘ.
3) The predicted load can be modified to account for the difference between the input xᵢₙₚᵤₜ and xₙₒₘ.

$${load}_{predicted , modified} = {load}_{predicted} + ( {x}_{input , forecast} - {x}_{nom} ) \times {[ \frac{d ( load )}{d ( {x}_{input} )} ]}_{{x}_{n o m}}$$

The same approach can be used for modifying a generation prediction by replacing “load” with “generation” in the formula above.

### Define the Control Parameter Set X

Defining the Control Parameter Set X involves defining or otherwise specifying times at which each control parameter is to be applied during a future time domain, and the control law(s) that are to be applied at each time in the future time domain.

An EO, according to certain embodiments of the present disclosure, is configured to define the control parameter set X. While there are many ways to define a control parameter set X, three possible approaches are:
1. a single set of parameters of a control law to be applied during the entire upcoming time domain;
2. a sequence of parameter sets that are each to be applied to a single control law at different contiguous sequential time intervals throughout the upcoming time domain; and
3. a sequence of parameters that specifies different control laws to be applied at different contiguous sequential time intervals throughout the future time domain.

An example of Approach 1 above of a single set of parameters of the control parameter set X (and example values) for a four-parameter control law is shown in Table 1.

TABLE 1

| | | Example | |
|---|---|---|---|
| Parameter | Description | Value | |
| Pₙₒₘ | Nominal ESS power (or discharge | −40 | W |
| | power if negative) to be applied in | | |
| | the absence of other constraints or | | |
| | rules (such as those related to | | |
| | UB, UB₀, or LB below). | | |
| UB | Upper bound on adjusted demand (e.g., | 100 | kW |
| | an upper setpoint). Not to be | | |
| | exceeded unless the ESS is incapable | | |
| | of discharging at sufficient power. | | |
| UB₀ | Upper bound on electrical system | 80 | kW |
| | adjusted demand (e.g., an upper | | |
| | setpoint). Not to be actively | | |
| | exceeded (e.g., electrical | | |
| | system adjusted demand may exceed | | |
| | this value only with ESS power less | | |
| | than or equal to 0). | | |
| LB | Lower bound on adjusted net power | 0 | kW |
| | (e.g., a lower setpoint). Sometimes | | |

referred to as “minimum import”
or, if 0, “zero export.”
Adjusted net power will be kept above
this value unless the ESS is incapable of
charging at sufficient power and generators
cannot be throttled sufficiently.

Approaches 2 and 3 above utilize segmentation of the future time domain.

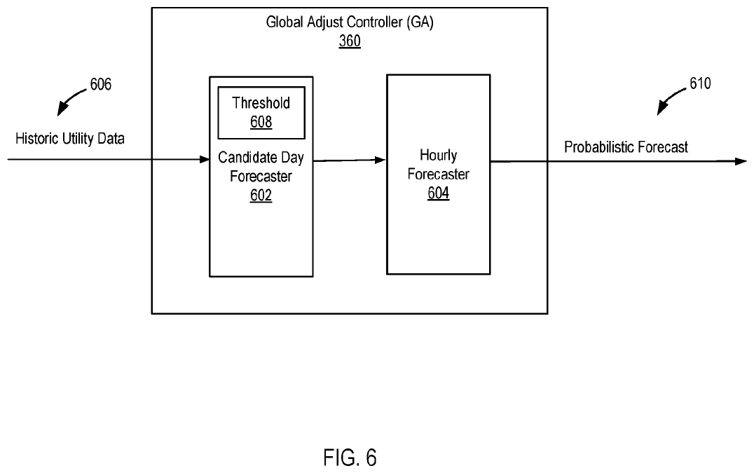

FIG. 6 illustrates a block diagram of a GA 360, according to one embodiment of the present disclosure. The GA 360 may include two forecasters. The forecasters may be a candidate day forecaster 602 and an hourly forecaster 604. The GA 360 uses the candidate day forecaster 602 to forecast whether a given day is a candidate system peak day and the hourly forecaster 604 to forecast peak hours.

The candidate day forecaster 602 may receive historic utility data 606 and determine a power threshold 608. The historic utility data 606 may include past power data of the utility, including past peak loads. The power threshold 608 may be a threshold that indicates that a day may include a utility peak that is incentivized by a system peak utility program.

Each day, the candidate day forecaster 602 may use a machine learning model to forecast the utility or ISO electricity load for the next 24 hours. In some embodiments, the forecaster 602 may utilize a neural network to forecast the utility or ISO electricity load for the next 24 hours. In some embodiments, the forecaster 602 may utilize a neural network regression technique (e.g., a neural network regression algorithm, a neural network regression model) to forecast the utility or ISO electricity load for the next 24 hours. The machine learning model may use the historic utility data. The historic utility data may be preprocessed, such as for training and/or testing the machine learning model. In some embodiments, the machine learning model may include an appropriate loss function for a regression problem (e.g., Mean Squared Error (MSE)). The candidate day forecaster 602 may compare each hour of the forecast to the power threshold 608. In some embodiments, if any part of the forecast is above the power threshold, the next day is considered a possible system peak day also referred to as a candidate utility peak period. The candidate utility peak period is a day in which it is possible or probable a utility electricity peak hour will occur.

The power threshold 608 can be determined in a number of ways. In some embodiments, the power threshold 608 can be set manually. In some embodiments, the power threshold 608 may be determined by the candidate day forecaster 602 based on historic electricity peaks of the utility from the historic utility data 606. For example, suppose X represents the number of utility electricity peaks in a given year for a utility system peak program. The power threshold 608 can be based off of the last X historic peaks. For instance, in some embodiments, the power threshold 608 may be the average of the last X peaks. In some embodiments, the power threshold 608 may be the minimum of the last X historical peaks. In some embodiments, the power threshold 608 may be the minimum of the last X historical peaks that happened the previous year.

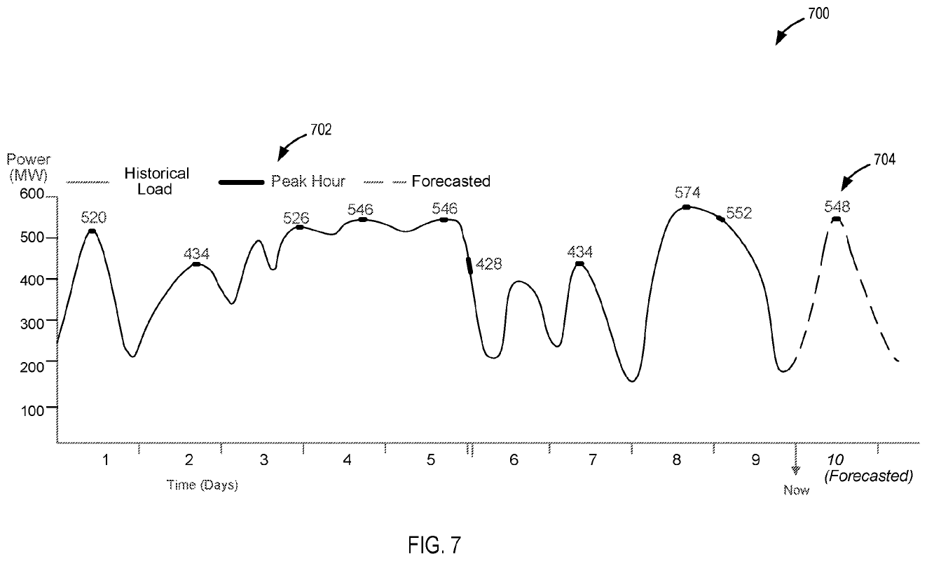

To illustrate how the candidate day forecaster 602 may use the historic utility data 606 to determine the power threshold 608, FIG. 7 provides a graph 700 illustrating historic load data of the utility for a past nine days. While the embodiments discussed in relation to FIG. 7 mention nine days, the window for the past data analysis may be set to any time frame. For example, the past data used to determine the power threshold 608 may be an entire year. In some embodiments, the window of the past data may be set to the previous calendar year.

Marked along the graph 700 are peak hours 702 for each of the nine past days and a forecasted peak 704 for the tenth day. In an embodiment where the threshold is determined by taking the average of the highest four peaks from the last nine days, the threshold would be: (574+552+546+546)/4=554.5 MW. In embodiments where the threshold is determined by taking the minimum of the highest four peaks from the current year, the threshold would be 546 MW.

In other embodiments, only a portion of the historical load data may be used to determine the threshold. For example, suppose the threshold may be determined by taking the average of the highest 4 peaks from the first 5 days, the threshold would be determined by: (546+546+526+520)/4. Thus, the threshold in such an embodiment would be 532.4 MW. Similar embodiments may use a minimum or average of the last X historical peaks that happened the previous calendar year.

Returning to FIG. 6, the candidate day forecaster 602 may compare the forecasted utility or ISO electricity load to the power threshold 608 to determine if the upcoming day is a candidate utility peak period in several ways. For example, in some embodiments, the candidate day forecaster 602 may determine that the upcoming day is a candidate utility peak period if the minimum forecast utility electrical load is greater than the power threshold 608. For instance, with reference to FIG. 7, the forecasted low of the tenth day is around 200 MW. If the power threshold 608 is set to 546 MW the tenth day would not be considered a candidate utility peak period in such an embodiment.

In some embodiments, the candidate day forecaster 602 may determine that the upcoming day is a candidate utility peak period if the maximum forecast utility electrical load is greater than the power threshold 608. For instance, with reference to FIG. 7, the forecasted high of the tenth day is 548 MW. If the power threshold 608 is set to 546 MW the tenth day would be considered a candidate utility peak period in such an embodiment.

In some embodiments, the candidate day forecaster 602 may determine that the upcoming day is a candidate utility peak period if the hourly average forecast utility electrical load is greater than the power threshold 608. For instance, with reference to FIG. 7, the hourly average of the tenth day is 380 MW. If the power threshold 608 is set to 546 MW the tenth day would not be considered a candidate utility peak period in such an embodiment.

If the candidate day forecaster 602 determines that the upcoming day is not a candidate system peak day no further steps may be performed. For example, the hourly forecaster 604 may not be used and a probabilistic forecast 610 may not be output. Thus, a site controller (e.g., EOESC 310) may provide control of the battery without any consideration of potential revenue from the utility peak value stream that day.

If the candidate day forecaster 602 determines that the upcoming day is a candidate system peak, the hourly forecaster 604 may predict the highest hours of the upcoming day. In some embodiments, the hourly forecaster 604 may operate at a periodic time. In some embodiments, the hourly forecaster 604 may operate before any control signals are provided from a site controller to a site.

For example, in some embodiments, every fifteen-minute interval of a candidate system peak day, the hourly forecaster 604 may predict the peak hours of the day. In some embodiments, the prediction may be done using a machine learning model. In some embodiments the prediction may be done using a neural network classification technique (e.g., a neural network classification model, a neural network classification algorithm). The hourly forecaster 604 may determine probabilities for each hour of the next twenty-four hours of the probability of there being a peak that hour.

The hourly forecaster 604 may compile the probabilities into a probabilistic forecast 610 to send to a site controller. The entire day's worth of forecasted hours can be included in the probabilistic forecast 610 or a subset of hours can be included in the probabilistic forecast 610. A site controller may assume any hour without a probability to have a 0% chance of being a system peak hour.

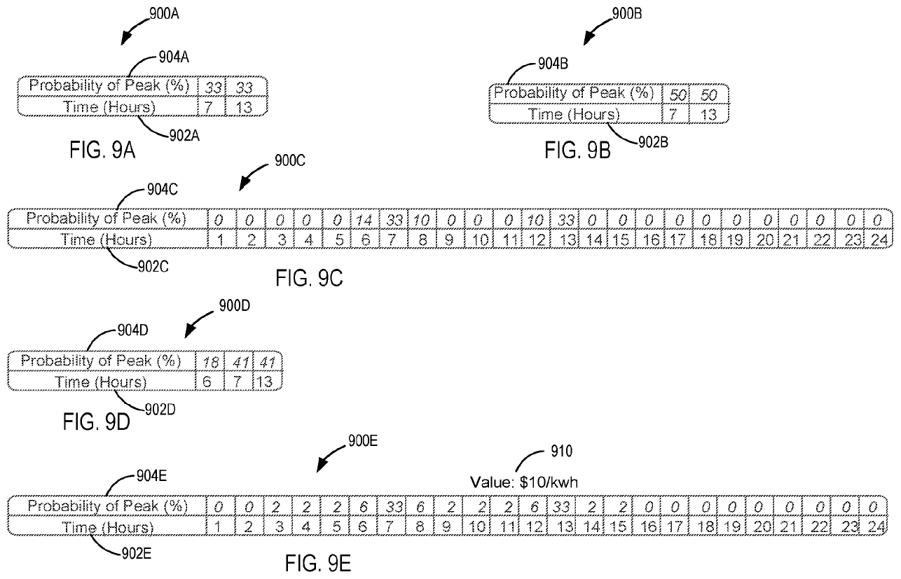

Each specific hour of the probabilistic forecast 610 may be formed into a Contract Maneuver (CM). The CM may include a time, duration, value, and probability associated with it. A site may receive a series of CMs to represent the probabilistic forecast 610. FIGS. 9A-9E illustrate various formats of a probabilistic forecast 610. In FIGS. 9A-9E, each column in each table represents a CM that ends at the time specified in the time row 902A-902E. In the illustrated embodiments, each CM has a duration of 1 hour, and a probability depicted in the probability row 904A-904E.

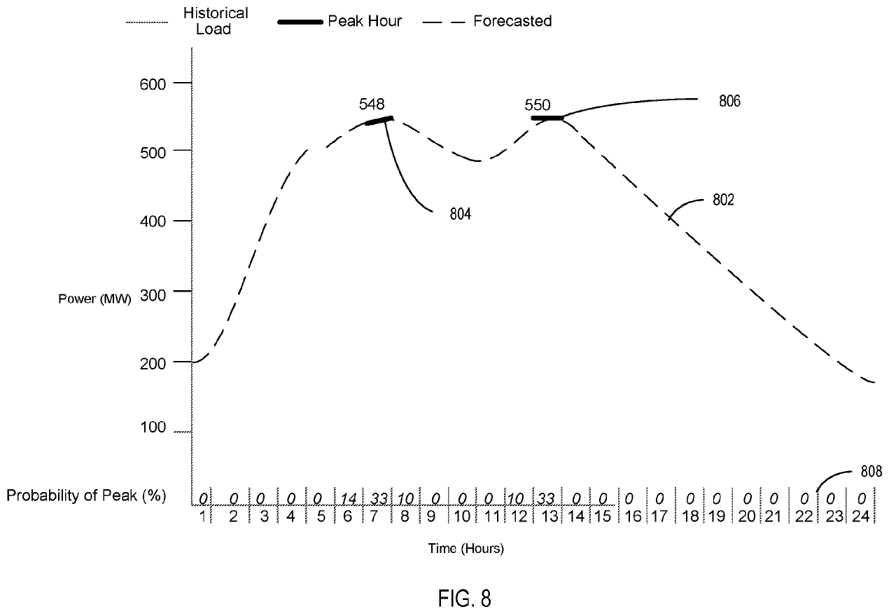

To illustrate various ways that the probabilistic forecast 610 may be compiled, FIG. 8 illustrates an example forecasted utility load 802. Based on the forecasted utility load 802 there are two peaks. The first peak 804 is 548 MW and the second peak 806 is 550 MW. A probability row 808 shows a probability for each hour to include a utility electricity peak of a system peak utility program. In some embodiments, the GA may compile the entire probability row 808 into a probabilistic forecast to send to a site controller. In other embodiments, a subset of probabilities may be sent to the site controller.

FIGS. 9A-9E illustrate various ways in which a GA may compile the probabilities associated with the example forecasted utility load 802 of FIG. 8 into CMs to form a probabilistic forecast 900A-900E. In some embodiments, a GA may communicate the probabilistic forecast to a site controller via cloud messaging using a series of CMs.

As shown in FIGS. 9A-9E, the number of CMs may vary. In some embodiments, the number of hours or CMs in the probabilistic forecast (e.g., probabilistic forecast 610) may be correlated to the energy size and inverter power of the ESS. For example, the number of hours the battery can last (provide power to the site electrical system load) may be determined by dividing the energy size by the inverter power. In some embodiments, the number of hours in the probabilistic forecast 610 matches the number of hours that the ESS can last.

For example, if the ESS can only last two hours (i.e., a 2-hr ESS), in these embodiments, two peak hours would be included in the probabilistic forecast 610 when sent to the site controller. The two peak hours may be sent to the site controller as two CMs. FIG. 9A illustrates a probabilistic forecast 900A comprising CMs for the two peak hours of the forecasted utility load 802 of FIG. 8. As shown in FIG. 8, hours 7 and 13 (representing 6-7 am and 1-2 μm) are the two hours most likely including a utility electricity peak, each of these two hours corresponding to a probability of 33%. In FIG. 9A the time and probabilities associated with hours 7 and 13 are compiled into two CMs forming a probabilistic forecast 900A and sent to a site controller.

FIG. 9B illustrates an embodiment in which the GA renormalizes the CMs to generate a probabilistic forecast 900B. In other words, the GA may alter the probabilities based on the number of CMs or hours included in a probabilistic forecast. For example, since the time row 902B only includes two hours, the probabilities row 904B may be renormalized causing each probability to be altered from 33% to 50%.

FIG. 9C illustrates a probabilistic forecast 900C comprising CMs for each of the hours of the forecasted utility load 802 of FIG. 8. In this embodiment, the site controller would receive twenty-four CMs. FIG. 9C illustrates the hour-probability pairs (i.e., CMs) that could be sent to the site in the probabilistic forecast 900C.

FIG. 9D illustrates a probabilistic forecast 900D according to another embodiment. In FIG. 9D, the number of hours passed in the probabilistic forecast 900C is correlated to the want of risk-reward tolerance of the customer. To decrease risk, but also reward, the number of CMs with potential peak hours passed from the GA to a site controller on a candidate system peak day may be greater than how long an ESS lasts. For example, in a 2-hr ESS, three peak hours may be passed under this implementation as CMs. The probabilistic forecast 900D illustrates an example of this implementation in which the three top probabilities are normalized and sent to the site controller.

FIG. 9E Illustrates a probabilistic forecast 900E with padded probabilities. In some embodiments, in addition to the subset of peak hours as specified in any of the previously-listed embodiments of probabilistic forecasts, a GA may pad hours before and after a potential peak event with low probabilities and passed to the site as CMs. Advantageously this embodiment may disincentivize a site to charge during hours before the event or immediately after the event which may be naturally ‘riskier’ hours to be charging, in the case where the peaks actually occur at non-forecasted times. For example, if the GA projects peaks from 5 am to 8 am and from 11 am to 1 μm, in addition to preparing CMs at these peaks, prior to 5 am, between 8 am and 11 am, and after 1 μm with CMs with probabilities of 5% or lower may also be generated and passed to the site. In some embodiments, probabilities can be renormalized after padding occurs. In other embodiments, the probabilities may not be renormalized. FIG. 9E illustrates an example where the probabilistic forecast 900E for the forecasted utility load 802 of FIG. 8 is padded and renormalized. FIG. 9E also illustrates a value 910 associated with the CMs. The value may be an amount of value to be provided per an amount of energy provided (e.g., conserved, generated) by an adjustment to operation. In the illustrated embodiment of FIG. 9E, the value is fixed. In other embodiments, the value may vary, such as according to a schedule, a mapping, a formula, a function, or the like.

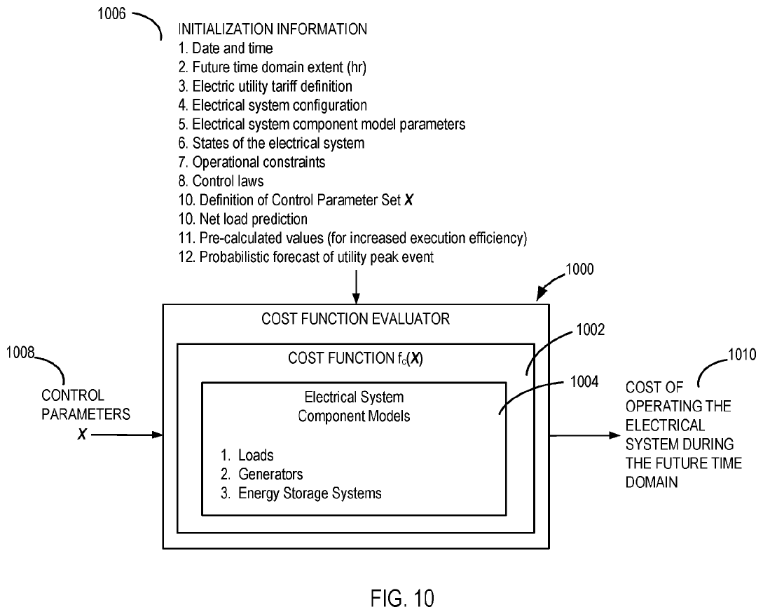

FIG. 10 is a diagrammatic representation of a cost function evaluation module 1000 (or cost function evaluator) that implements a cost function fc (X) 1002 that includes models 1004 for one or more electrical system components (e.g., loads, generators, ESSs). The cost function fc (X) 1002 receives as inputs initialization information 1006 and control parameters 1008 (e.g., a control parameter set X). The cost function fc (X) 1002 provides as an output a scalar value 1010 representing a cost of operating the electrical system during the future time domain.

The scalar value 1010 representing the cost, which is the output of the cost function fc (X) 1002, can have a variety of different units in different examples. For example, it can have units of any currency. Alternatively, the cost can have units of anything with an associated cost or value, such as electrical energy or energy credits. The cost can also be an absolute cost, a cost per future time domain, or a cost per unit time such as cost per day. In one embodiment, the units of cost are U.S. dollars per day.

Prior to using the cost function fc (X) 1002, several elements of it can be initialized. The initialization information 1006 that is provided in one embodiment may include one or more of:
Date and time. This information is used to determine the applicable electric utility rates.
Future time domain extent. This defines the time extent of the cost calculation.
Electric utility tariff definition. This is a set of parameters that defines how the electrical utility calculates charges.
Electrical system configuration. These configuration elements specify the sizes and configuration of the components of the electrical system. An example for a battery ESS is the energy capacity of the energy storage device.
Electrical system component model parameters. These model parameters work in conjunction with analytic or numerical models to describe the physical and electrical behavior and relationships governing the operation of electrical components in the electrical system. For battery ESSs, a “battery model” is a component, and these parameters specify the properties of the battery such as its Ohmic efficiency, Coulombic efficiency, and degradation rate as a function of its usage.
States of the electrical system. This information specifies the state of components in the electrical system that are important to the economic optimization. For battery ESSs, one example state is the SoC of the energy storage device.
Operational constraints. This information specifies any additional operational constraints on the electrical system, such as minimum import power.
Control law(s). The control law or laws are associated with the definition of X.
Definition of control parameter set X. This may indicate the times at which each control parameter is to be applied during a future time domain and may indicate which control law(s) are to be applied at each time in the future time domain.
Net load (or power) prediction. This is the predicted unadjusted net load (or predicted unadjusted net power) during the future time domain.
Pre-calculated values. While segments are defined, many values may be calculated that the cost function can use to increase execution efficiency (help it “evaluate” faster). Pre-calculation of these values may be a desirable aspect of preparing the cost function to enable the cost function to be evaluated more efficiently (e.g., faster, with fewer resources).
Probabilistic forecast of a utility peak event. The probabilistic forecast of a utility peak event may allow the cost function to consider potential value of a system peak utility program.

Preparing the cost function fc (X) 1002 can increase execution efficiency of the EO because values that would otherwise be re-calculated each time the cost function is evaluated (possible thousands of times per EO iteration) are pre-calculated a single time.

The cost function evaluation module 1000, having received the CMs (i.e., probabilistic forecast of utility peak event) can prepare a cost estimate taking into account a value stream from potential utility peak events (i.e., system peak value stream). The cost estimate may be optimized by a site controller to define a control parameter set. The cost function fc (X) 1002 can have any number of other cost types including demand capping, energy arbitrage, demand response, and battery degradation in addition to the system peak value stream.

The value of the system peak value stream may be determined based on the CMs of the probabilistic forecast. For example, the system peak value stream may be equal to the sum of the CM costs. In some embodiments, each CM cost may be the multiplication of the probability of a system peak at the given hour, the ESS inverter power (KW), the incentive ($/(kWh)), and the duration of the maneuver. In some embodiments, the duration of the maneuver may be one hour.

In some embodiments, the cost function may be:

$$Economic Cost of Site = Cost of Demand Capping + Cost of Energy Arbitrage + Cost of Demand Response + Cost of Battery Degradation + Cost of System Peak$$

$$where :$$

$$Cost of System Peak = {\sum }_{i = 0}^{i = Number of Contract Maneuver Costs} Contract Maneuver {Cost}_{i}$$

$$where :$$

$$Contract Maneuver Cost = Probability * ESS Inverter Power * Incentive * Duration of Maneuver$$

The CMs may incentivize the ESS to discharge during events when no competing costs prevent this occurrence. If incentives are appropriately high, the ESS may prioritize the system peak value stream. Incentives may be otherwise calculated by the actual incentive of participating in a system peak program. The ESS may also prioritize discharging during CMs with the highest probabilities, should there be competing CMs, as may lead to the lowest cost when optimization occurs.

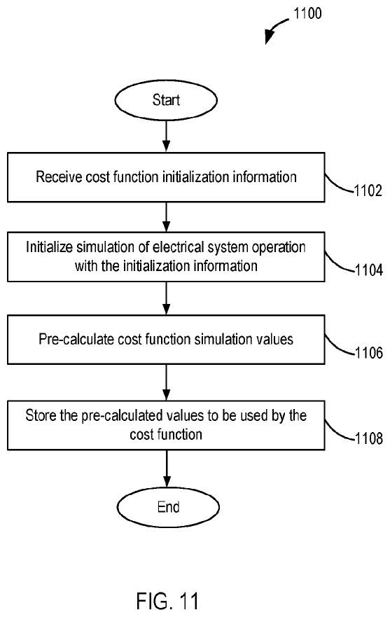

FIG. 11 is a flow diagram of a process 1100 of preparing a cost function fc (X), according to one embodiment of the present disclosure. Cost function initialization information may be received 1102, including any long-term adjustment factor. A simulation of electrical system operation is initialized 1104 with the received 1102 cost function initialization information. Cost function values may be pre-calculated 1106. The pre-calculated values may be stored 1108 for later use during evaluation of the cost function.

In certain embodiments, defining a control parameter set X and preparing a cost function fc (X) may be accomplished in parallel.

### Evaluation of the Cost Function

During execution of an EO, according to some embodiments of the present disclosure, the cost function is evaluated. During evaluation of the cost function, operation of the electrical system with the control parameter set X is simulated. The simulation may be an aspect of evaluating the cost function. Stated otherwise, one part of evaluating the cost function for a given control parameter set X may be simulating operation of the electrical system with that given control parameter set X. In the simulation, the control parameter set X is applied to the predicted load and predicted power generation to get an adjusted load and a simulation of operation of the electrical system over the future time domain. As time advances through the future time domain in the simulation, costs and benefits (as negative costs) can be accumulated.

What is finally returned by the simulation is a representation of how the electrical system state may evolve during the future time domain with control X, and what costs may be incurred during that time.

In some embodiments, the cost function, when evaluated, returns the cost of operating the electrical system with some specific control parameter set X. As can be appreciated, the cost of operating an electrical system may be very different depending on X. So evaluation of the cost function includes a simulated operation of the electrical system with X first. The result of the simulation can be used to estimate the cost associated with that scenario (e.g., the control parameter set X).

As noted previously, some of the costs considered by the cost function in one embodiment are:
1. Electricity supply charges (both flat rates and ToU rates)
2. Electricity demand charges
3. Battery degradation cost
4. Reduction of energy stored in the ESS
5. Incentive maneuver benefits (as a negative number) including a system peak value stream from system peak utility programs.

Electricity supply and demand charges have already been described. For monthly demand charges, the charge may be calculated as an equivalent daily charge by dividing the charge by approximately 30 days, or by dividing by some other number of days, depending on how many days are remaining in the billing cycle. Battery degradation cost is described in a later section. Reduction in energy stored in an ESS accounts for the difference in value of the storage energy at the beginning of the future time domain compared to the end. Incentive maneuver benefits such as demand response can be calculated as the benefit on a per-day basis, but as a negative number.

During the cost function's electrical system simulation, several variables can be tracked and stored in memory. These include control variables, electrical power consumed by or supplied from various electrical systems, and the states of charge of any ESSs. Other variables can also be tracked and stored to memory. Any of the variables stored to memory can be output by the cost function.

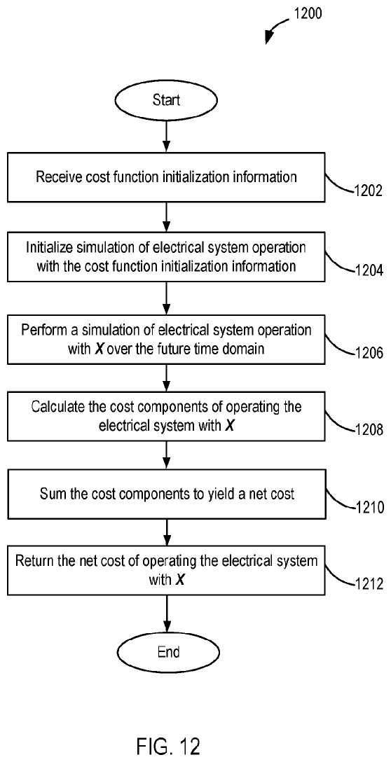

FIG. 12 is a flow diagram of a method 1200 of evaluating a cost function, according to one embodiment of the present disclosure. The cost function may be received from an external source or otherwise unprepared. Cost function initialization information may be received 1202. A simulation of electrical system operation is initialized 1204 with the received 1202 cost function initialization information. The simulation is performed 1206 of the electrical system operation with control parameter set X over the future time domain. A calculation 1208 of the cost components of operating the electrical system with control parameter set X is performed. The cost components are summed 1210 to yield a net cost of operating the electrical system with control parameter set X. The net cost of operating the electrical system with control parameter set X is returned 1212 or otherwise output.

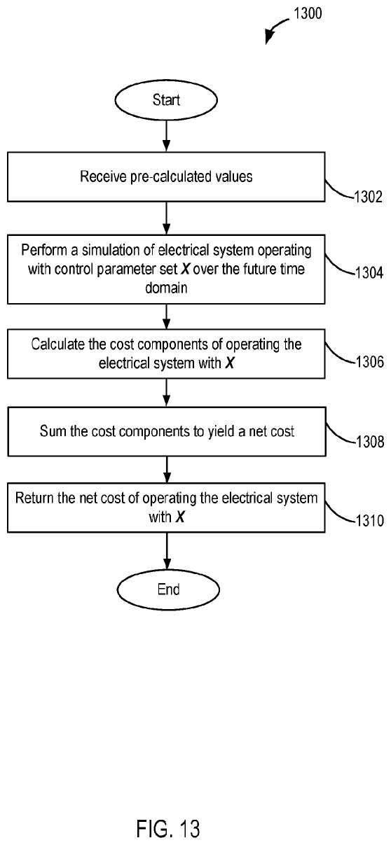

FIG. 13 is a flow diagram of a method 1300 of evaluating a prepared cost function, according to one embodiment of the present disclosure. The cost function may be prepared according to the method of FIG. 12. Pre-calculated values are received 1302 as inputs to the method 1300. The values may be pre-calculated during an operation to prepare the cost function, such as the process of FIG. 12. A simulation is performed 1304 of the electrical system operating with control parameter set X over the future time domain. A calculation 1306 of the cost components of operating the electrical system with control parameter set X is performed. The cost components are summed 1308 to yield a net cost of operating the electrical system with control parameter set X. The net cost of operating the electrical system with control parameter set X is returned 1310 or otherwise output.

In some embodiments, rather than returning the net cost of operating the electrical system with control parameter set X during the future time domain, what is returned is the net cost of operating the electrical system with control parameter set X as a cost per unit time (such as an operating cost in dollars per day). Returning a per-day cost can provide better normalization between the different cost elements that comprise the cost function. The cost per day, for example, can be determined by multiplying the cost of operating during the future time domain by 24 hours and dividing by the length (in hours) of the future time domain.

### Execute Continuous Minimization of the Cost Function

With a prediction of load and generation made, the control parameter set X defined, and the cost function obtained and initialized and/or prepared, minimization of cost can be performed.

Minimization of the cost function may be performed by an optimization process or module that is based on an optimization algorithm. Minimization (or optimization) may include evaluating the cost function iteratively with different sets of values for the control parameter set X (e.g., trying different permutations from an initial value) until a minimum cost (e.g., a minimum value of the cost function) is determined. In other words, the algorithm may iteratively update or otherwise change values for the control parameter set X until the cost function value (e.g. result) converges at a minimum (e.g., within a prescribed tolerance). The iterative updating or changing of the values may include perturbing or varying one or more values based on prior one or more values.

Termination criteria (e.g., a prescribed tolerance, a delta from a prior value, a prescribed number of iterations) may aid in determining when convergence at a minimum is achieved and stopping the iterations in a finite and reasonable amount of time. The number of iterations that may be performed to determine a minimum could vary from one optimization cycle to a next optimization cycle. The set of values of the control parameter set X that results in the cost function returning the lowest value may be determined to be the optimal control parameter set Xₒₚₜ.

In one embodiment, a numerical or computational generalized constrained nonlinear continuous optimization (or minimization) algorithm is called (e.g., executed) by a computing device.

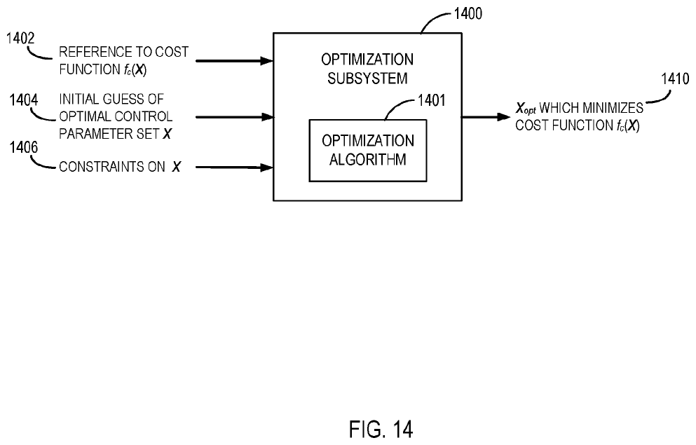

FIG. 14 is a diagrammatic representation of an optimization subsystem 1400 that utilizes or otherwise implements an optimization algorithm 1401 to determine an optimal control parameter set Xₒₚₜ 1410, which minimizes the cost function fc (X). In the embodiment of FIG. 14, the optimization algorithm 1401 utilized by the optimization subsystem 1400 may be a generalized constrained multivariable continuous optimization (or minimization) algorithm. A reference 1402 is provided for the cost function fc (X).

The optimization algorithm 1401 can be implemented in software, hardware, firmware, or any combination of these. The optimization algorithm 1401 may be implemented based on any approach from descriptions in literature or pre-written code, or developed from first principles. The optimization algorithm implementation can also be tailored to the specific problem of electrical system economic optimization, as appropriate in some embodiments.

Some algorithms for generalized constrained multivariable continuous optimization include:
Trust-region reflective
Active set
SQP
Interior Point
Covariance Matrix Adaption Evolution Strategy (CMAES)
Bound Optimization by Quadratic Approximation (BOBYQA)
Constrained Optimization by Linear Approximation (COBYLA)

The optimization algorithm 1401 may also be a hybrid of more than one optimization algorithm. For example, the optimization algorithm 1401 may use CMAES to find a rough solution, then Interior Point to converge tightly to a minimum cost. Such hybrid methods may produce robust convergence to an optimum solution in less time than single-algorithm methods.

Regardless of the algorithm chosen, it may be useful to make an initial guess 1404 of the control parameter set X. This initial guess 1404 enables an iterative algorithm such as those listed above to more quickly find a minimum. In one embodiment, the initial guess 1404 is derived from the previous EO execution results.

Any constraints 1406 on X can also be defined or otherwise provided. Example constraints 1406 include any minimum or maximum control parameters for the electrical system.

### Apparatus Architectures

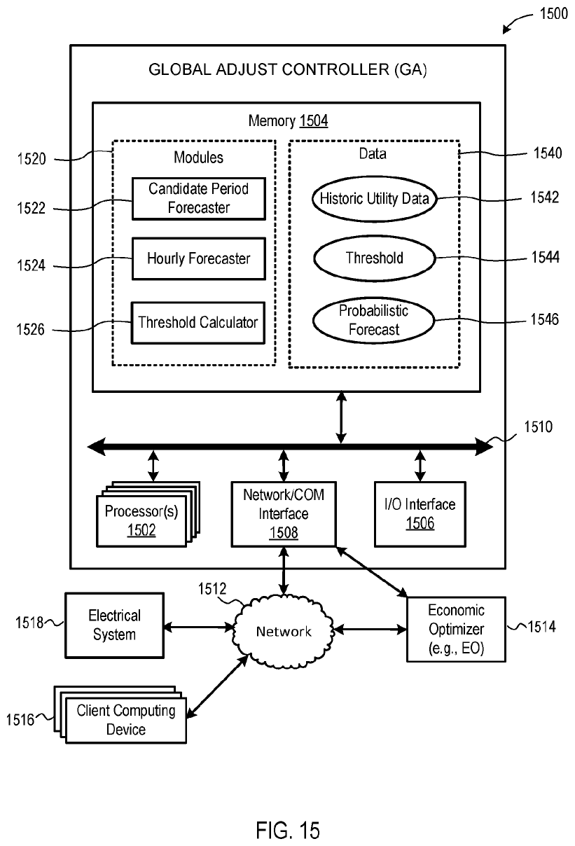

FIG. 15 is a diagram of an GA 1500 according to one embodiment of the present disclosure. The GA 1500 may determine a probabilistic forecast 1546 to be used by a site controller as part of a cost function to effectuate a change to the electrical system 1518. The GA 1500 may determine the probabilistic forecast 1546 based on a threshold 1544 and a predicted utility load. The predicted utility load and threshold may be based on the historic utility data 1542. The GA 1500 may include one or more processors 1502, memory 1504, an input/output interface 1506, a network/COM interface 1508, and a system bus 1510.

The one or more processors 1502 may include one or more general purpose devices, such as an Intel®, AMD®, or other standard microprocessor. The one or more processors 1502 may include a special purpose processing device, such as ASIC, SoC, SiP, FPGA, PAL, PLA, FPLA, PLD, or other customized or programmable device. The one or more processors 1502 perform distributed (e.g., parallel) processing to execute or otherwise implement functionalities of the present embodiments. The one or more processors 1502 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 1504 may include static RAM, dynamic RAM, flash memory, one or more flip-flops, ROM, CD-ROM, DVD, disk, tape, or magnetic, optical, or other computer storage medium. The memory 1504 may include a plurality of program modules 1520 and data 1540.

The program modules 1520 may include all or portions of other elements of the GA 1500. The program modules 1520 may run multiple operations concurrently or in parallel by or on the one or more processors 1502. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems and/or the like.

The system memory 1504 may also include the data 1540. Data generated by the GA 1500, such as by the program modules 1520 or other modules, may be stored on the system memory 1504, for example, as stored program data. The data 1540 may be organized as one or more databases.

The input/output interface 1506 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network/COM interface 1508 may facilitate communication or other interaction with other computing devices 1516 (e.g., an economic optimizer 1514) and/or networks 1512, such as the Internet and/or other computing and/or communications networks. The network/COM interface 1508 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network/COM interface 1508 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth. The network/COM interface 1508 may be any appropriate communication interface for communicating with other systems and/or devices.

The system bus 1510 may facilitate communication and/or interaction between the other components of the system, including the one or more processors 1502, the memory 1504, the input/output interface 1506, and the network/COM interface 1508.

The modules 1520 may include a candidate period forecaster 1522, an hourly forecaster 1524, and a threshold calculator 1526. The candidate day forecaster 1522 may forecast the utility electricity load for an upcoming period (e.g., the next 24 hours), compare a forecasted load of the upcoming period to a power threshold, and identify the upcoming period as a candidate utility peak period when the forecasted load for at least one segment of the upcoming period is above the power threshold. The hourly forecaster 1524 may generate a probabilistic forecast for the upcoming period of time. The threshold calculator 1526 may calculate the threshold 1544 based on historic peaks within the historic utility data 1542.

The data 1540 may include historic utility data 1542, a threshold, 1544, and a probabilistic forecast 1546. The GA 1500 may send the probabilistic forecast 1546 to the EO 1514 through the network/COM interface 1508.

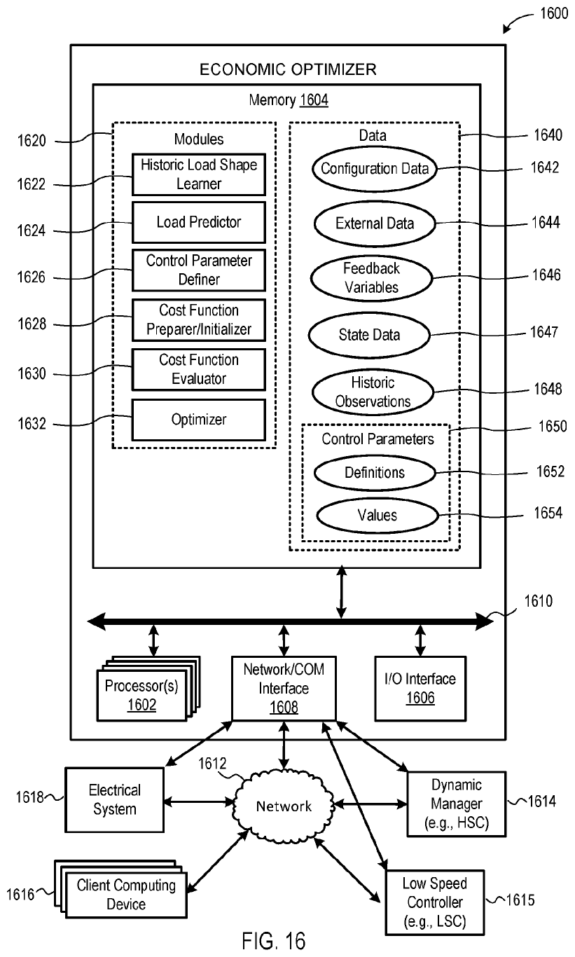

FIG. 16 is a diagram of an EO 1600 according to one embodiment of the present disclosure. The EO 1600 may determine a control plan for managing control of an electrical system 1618 during an upcoming time domain and provide the control plan as output. The determined control plan may include a plurality of sets of parameters each to be applied for a different time segment within an upcoming time domain. The EO 1600 may determine the control plan based on a set of configuration elements specifying one or more constraints of the electrical system 1618 and defining one or more cost elements associated with operation of the electrical system 1618. The EO 1600 may also determine the control plan based on a set of process variables that provide one or more measurements of a state of the electrical system 1618. The EO 1600 may include one or more processors 1602, memory 1604, an input/output interface 1606, a network/COM interface 1608, and a system bus 1610.

The one or more processors 1602 may include one or more general purpose devices, such as an Intel®, AMD®, or other standard microprocessor. The one or more processors 1602 may include a special purpose processing device, such as ASIC, SoC, SiP, FPGA, PAL, PLA, FPLA, PLD, or other customized or programmable device. The one or more processors 1602 perform distributed (e.g., parallel) processing to execute or otherwise implement functionalities of the present embodiments. The one or more processors 1602 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 1604 may include static RAM, dynamic RAM, flash memory, one or more flip-flops, ROM, CD-ROM, DVD, disk, tape, or magnetic, optical, or other computer storage medium. The memory 1604 may include a plurality of program modules 1620 and data 1640.

The program modules 1620 may include all or portions of other elements of the EO 1600. The program modules 1620 may run multiple operations concurrently or in parallel by or on the one or more processors 1602. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems and/or the like.

The system memory 1604 may also include the data 1640. Data generated by the EO 1600, such as by the program modules 1620 or other modules, may be stored on the system memory 1604, for example, as stored program data 1640. The data 1640 may be organized as one or more databases.

The input/output interface 1606 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network/COM interface 1608 may facilitate communication or other interaction with other computing devices (e.g., a dynamic manager 1614 and a low speed controller 1615) and/or networks 1612, such as the Internet and/or other computing and/or communications networks. The network/COM interface 1608 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network/COM interface 1608 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth. The network/COM interface 1608 may be any appropriate communication interface for communicating with other systems and/or devices.

The system bus 1610 may facilitate communication and/or interaction between the other components of the system, including the one or more processors 1602, the memory 1604, the input/output interface 1606, and the network/COM interface 1608.

The modules 1620 may include a historic load shape learner 1622, a load predictor 1624, a control parameter definer 1626, a cost function preparer/initializer 1628, a cost function evaluator 1630, and an optimizer 1632.

The historic load shape learner 1622 may compile or otherwise gather historic trends to determine a historic profile or an average load shape that may be used for load prediction. The historic load shape learner 1622 may determine and update an avg_load_shape array and an avg_load_shape_time_of_day array by recording load observations and using an approach to determine a suitable average of the historic load observations after multiple periods of time. The historic load shape learner 1622 may utilize a process or an approach to determining the historic average profile such as described above with reference to FIG. 8.

The load predictor 1624 may predict a load on the electrical system 1618 during an upcoming time domain. The load predictor 1624 may utilize a historic profile or historic load observations provided by the historic load shape learner 1622. The load predictor 1624 may utilize a load prediction method such as described above with reference to FIGS. 7 and 8.

The control parameter definer 1626 may generate, create, or otherwise define a control parameter set X, in accordance with a control law. The created control parameters 1650 may include a definition 1652 and a value 1654 and may be stored as data 1640.

The cost function preparer/initializer 1628 prepares or otherwise obtains a cost function to operate on the control parameter set X. The cost function may include the one or more constraints and the one or more cost elements associated with operation of the electrical system 1618. The cost function preparer/initializer 1628 pre-calculates certain values that may be used during iterative evaluation of the cost function involved with optimization.

The cost function evaluator 1630 evaluates the cost function based on the control parameter set X. Evaluating the cost function simulates operation of the electrical system 1618 for a given time period under a given set of circumstances set forth in the control parameter set X and returns a cost of operating the electrical system 1618 during the given time period.

The optimizer 1632 may execute a minimization of the cost function by utilizing an optimization algorithm to find the set of values for the set of control variables. Optimization (e.g., minimization) of the cost function may include iteratively utilizing the cost function evaluator 1630 to evaluate the cost function with different sets of values for a control parameter set X until a minimum cost is determined. In other words, the algorithm may iteratively change values for the control parameter set X to identify an optimal set of values in accordance with one or more constraints and one or more cost elements associated with operation of the electrical system 1618.

The data 1640 may include configuration data 1642, external data 1644 process variables (e.g., feedback variables 1646), state data 1647, historic observations 1648, and control parameters 1650 (including definitions 1652 and values 1654).

The configuration data 1642 may be provided to, and received by, the EO 1600 to communicate constraints and characteristics of the electrical system 1618.

The external data 1644 may be received as external input (e.g., weather reports, changing tariffs, fuel costs, event data), which may inform the determination of the optimal set of values.

The process variables 1646 may be received as feedback from the electrical system 1618. The process variables 1646 are typically measurements of the state of the electrical system 1618 and are used to, among other things, determine how well objectives of controlling the electrical system 1618 are being met.

The state data 1647 would be any EO state information that may be helpful to be retained between one EO iteration and the next. An example is avg_load_shape.

The historic observations 1648 are the record of process variables 1646 that have been received. A good example is the set of historic load observations that may be useful in a load predictor algorithm.

As noted earlier, the control parameter definer 1626 may create control parameters 1650, which may include a definition 1652 and a value 1654 and may be stored as data 1640. The cost function evaluator 1630 and/or the optimizer 1632 can determine values 1654 for the control parameters 1650.

The EO 1600 may provide one or more control parameters 1650 as a control parameter set X to the dynamic manager 1614 via the network/COM interface 1608 and/or via the network 1612. The dynamic manager 1614 may then utilize the control parameter set X to determine values for a set of control variables to deliver to the electrical system 1618 to effectuate a change to the electrical system 1618 toward meeting one or more objectives (e.g., economic optimization) for controlling the electrical system 1618.

In other embodiments, the EO 1600 may communicate the control parameter set X directly to the electrical system 1618 via the network/COM interface 1608 and/or via the network 1612. In such embodiments, the electrical system 1618 may process the control parameter set X directly to determine control commands, and the dynamic manager 1614 may not be included.

In still other embodiments, the EO 1600 may determine values for a set of control variables 1650 (rather than for a control parameter set X) and may communicate the set of values for the control variables 1650 directly to the electrical system 1618 via the network/COM interface 1608 and/or via the network 1612.

One or more client computing devices 1616 may be coupled via the network 1612 and may be used to configure, provide inputs, or the like to the EO 1600, the dynamic manager 1614, and/or the electrical system 1618.

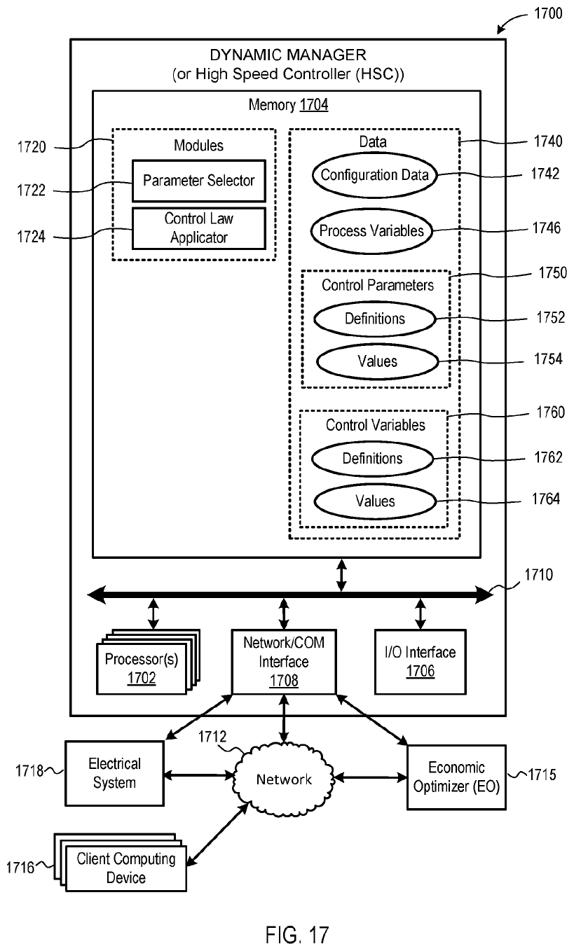

FIG. 17 is a diagram of a dynamic manager 1700, according to one embodiment of the present disclosure. The dynamic manager 1700, according to one embodiment of the present disclosure, is a second computing device that is separate from an EO 1715, which may be similar to the EO 1600 of FIG. 16. The dynamic manager 1700 may operate based on input (e.g., a control parameter set X) received from the EO 1715. The dynamic manager 1700 may determine a set of control values for a set of control variables for a given time segment of the upcoming time domain and provide the set of control values to an electrical system 1718 to effectuate a change to the electrical system 1718 toward meeting an objective (e.g., economical optimization) of the electrical system 1718 during an upcoming time domain. The dynamic manager 1700 determines the set of control values based on a control law and a set of values for a given control parameter set X. The dynamic manager 1700 may include one or more processors 1702, memory 1704, an input/output interface 1706, a network/COM interface 1708, and a system bus 1710.

The one or more processors 1702 may include one or more general purpose devices, such as an Intel®, AMD®, or other standard microprocessor. The one or more processors 1702 may include a special purpose processing device, such as ASIC, SoC, SiP, FPGA, PAL, PLA, FPLA, PLD, or other customized or programmable device. The one or more processors 1702 perform distributed (e.g., parallel) processing to execute or otherwise implement functionalities of the present embodiments. The one or more processors 1702 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 1704 may include static RAM, dynamic RAM, flash memory, one or more flip-flops, ROM, CD-ROM, DVD, disk, tape, or magnetic, optical, or other computer storage medium. The memory 1704 may include a plurality of program modules 1720 and program data 1740.

The program modules 1720 may include all or portions of other elements of the dynamic manager 1700. The program modules 1720 may run multiple operations concurrently or in parallel by or on the one or more processors 1702. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, and/or the like.

The system memory 1704 may also include data 1740. Data generated by the dynamic manager 1700, such as by the program modules 1720 or other modules, may be stored on the system memory 1704, for example, as stored program data 1740. The stored program data 1740 may be organized as one or more databases.

The input/output interface 1706 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network/COM interface 1708 may facilitate communication with other computing devices and/or networks 1712, such as the Internet and/or other computing and/or communications networks. The network/COM interface 1708 may couple (e.g., electrically couple) to a communication path (e.g., direct or via the network) to the electrical system 1718. The network/COM interface 1708 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network/COM interface 1708 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 1710 may facilitate communication and/or interaction between the other components of the system, including the one or more processors 1702, the memory 1704, the input/output interface 1706, and the network/COM interface 1708.

The modules 1720 may include a parameter selector 1722 and a control law applicator 1724.

The parameter selector 1722 may pick which set of parameters to be used from the control parameter set X, according to a given time segment.

The control law applicator 1724 may process the selected set of parameters from the control parameter set X and convert or translate the individual set of parameters into control variables (or values thereof). The control law applicator 1724 may apply logic and/or a translation process to determine a set of values for a set of control variables based on a given set of parameters (from a control parameter set X) for a corresponding time segment. For example, the control law applicator 1724 may apply a method and/or logic as shown in FIG. 16.

The data 1740 may include configuration data 1742, process variables 1746, control parameters 1750 (including definitions 1752 and values 1754), and/or control variables 1760 (including definitions 1762 and values 1764).

The configuration data 1742 may be provided to, and received by, the dynamic manager 1700 to communicate constraints and characteristics of the electrical system 1618.

The process variables 1746 may be received as feedback from the electrical system 1718. The process variables 1746 are typically measurements of the state of the electrical system 1718 and are used to, among other things, determine how well objectives of controlling the electrical system 1718 are being met. Historic process variables 1746 may be utilized by the dynamic manager 1700, for example, to calculate demand, which may be calculated as average building power over the previous 15 or 30 minutes. The dynamic manager 1700 can determine the set of control values for the set of control variables based on the process variables 1746.

The control parameters 1750 may comprise a control parameter set X that includes one or more sets of parameters each for a corresponding time segment of an upcoming time domain. The control parameters 1750 may additionally, or alternatively, provide a control plan for the upcoming time domain. The control parameters 1750 may be received from an EO 1715 as an optimal control parameter set Xₒₚₜ.

The control variables 1760 may be generated by the parameter selector 1722 based on an optimal control parameter set Xₒₚₜ.

The dynamic manager 1700 may receive the optimal control parameter set Xₒₚₜ from the EO 1715 via the network/COM interface 1708 and/or via the network 1712. The dynamic manager 1700 may also receive the process variables 1746 from the electrical system 1718 via the network/COM interface 1708 and/or via the network 1712.

The dynamic manager 1700 may provide the values for the set of control variables to the electrical system 1718 via the network/COM interface 1708 and/or via the network 1712.

One or more client computing devices 1716 may be coupled via the network 1712 and may be used to configure, provide inputs, or the like to the EO 1715, the dynamic manager 1700, and/or the electrical system 1718.

### EXAMPLE EMBODIMENTS

The following are some example embodiments within the scope of the disclosure. In order to avoid complexity in providing the disclosure, not all of the examples listed below are separately and explicitly disclosed as having been contemplated herein as combinable with all of the others of the examples listed below and other embodiments disclosed hereinabove. Unless one of ordinary skill in the art would understand that these examples listed below (and the above disclosed embodiments) are not combinable, it is contemplated within the scope of the disclosure that such examples and embodiments are combinable.

### Example 1

A global adjustment controller of an electrical system, the global adjustment controller comprising: a data storage device to store historic peak demand data for a utility; a communication interface to communicate with a system controller of an electrical system; one or more processors operably coupled to the data storage device and the communication interface, the one or more processors configured to: forecast the utility electricity load for an upcoming period; compare a forecasted load of the upcoming period to a power threshold; identify the upcoming period as a candidate utility peak period when the forecasted load for at least one segment of the upcoming period is above the power threshold, wherein the candidate utility peak period is a span of time in which it is possible a utility electricity peak segment will occur; generate, for the candidate utility peak period, a probabilistic forecast comprising probabilities for segments of the upcoming period indicating potential of the utility electricity peak occurring during a specified segment; provide, via the communication interface, the probabilistic forecast to an economic optimizer of the system controller, wherein the probabilistic forecast is used as a parameter for a cost function to determine one or more parameters to effectuate a change to the electrical system to attempt to participate in a system peak utility program.

### Example 2

The global adjustment controller of Example 1, wherein the upcoming period is 24 hours and each of the segment is an hour.

### Example 3

The global adjustment controller of Example 1, wherein the power threshold is an average of a set of latest historical utility peaks.

### Example 4

The global adjustment controller of Example 1, wherein the power threshold is a minimum of a set of latest historical utility peaks.

### Example 5

The global adjustment controller of Example 1, wherein the power threshold is a minimum of a set of utility peaks that happened during a previous year.

### Example 6

The global adjustment controller of Example 1, wherein the forecasted load for each segment is compared to the power threshold to identify the upcoming period of the as the candidate utility peak period.

### Example 7

The global adjustment controller of Example 1, wherein a minimum of the forecasted load is compared to the power threshold to identify the upcoming period of the as the candidate utility peak period.

### Example 8

The global adjustment controller of Example 1, wherein a maximum of the forecasted load is compared to the power threshold to identify the upcoming period of the as the candidate utility peak period.

### Example 9

The global adjustment controller of Example 1, wherein an hourly average of the forecasted load is compared to the power threshold to identify the upcoming period of the as the candidate utility peak period.

### Example 10

The global adjustment controller of Example 1, wherein how many segments and associated probabilities are in the probabilistic forecast is correlated to the energy size and inverter power of an ESS of the electrical system

### Example 11

The global adjustment controller of Example 10, wherein the processors are further configured to renormalize the probabilities in the probabilistic forecast based on how many segments and associated probabilities are in the probabilistic.

### Example 12

The global adjustment controller of Example 1, wherein the processors are further configured to pad probabilities for one or more segments before a predicted utility electricity peak and one or more segments after the predicted utility electricity peak.

### Example 13

The global adjustment controller of Example 1, wherein a machine learning neural network regression algorithm forecasts the utility electricity load.

### Example 14

The global adjustment controller of Example 1, wherein to generate the probabilistic forecast, every fifteen-minute interval of the candidate utility peak period, the processors forecast peak segments of the upcoming period using a machine learning classification model.

### Example 15

A method for controlling an electrical system, the method comprising: receiving historic peak demand data for a utility; forecasting the utility electricity load for an upcoming period based on the historic peak demand data; comparing a forecasted load of the upcoming period to a power threshold; identifying the upcoming period as a candidate utility peak period when the forecasted load for at least one segment of the upcoming period is above the power threshold, wherein the candidate utility peak period is a day in which it is possible a utility electricity peak segment will occur; generating, for the candidate utility peak period, a probabilistic forecast comprising probabilities for segments of the upcoming period indicating potential of the utility electricity peak occurring during a specified segment; providing, via a communication interface, the probabilistic forecast to an economic optimizer of the system controller, wherein the probabilistic forecast is used as a parameter for a cost function to determine one or more parameters to effectuate a change to the electrical system to attempt to participate in a system peak utility program.

### Example 16

The method of Example 15, wherein the upcoming period is 24 hours and each of the segments is an hour.

### Example 17

The method of Example 15, wherein the power threshold is an average of a set of latest historical utility peaks.

### Example 18

The method of Example 15, wherein the power threshold is a minimum of a set of latest historical utility peaks.

### Example 19

The method of Example 15, wherein the power threshold is a minimum of a set of utility peaks that happened during a previous year.

### Example 20

The method of Example 15, wherein the forecasted load for each segment is compared to the power threshold to identify the upcoming period of the as the candidate utility peak period.

The described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMS, EPROMS, EEPROMs, magnetic or optical cards, solid-state memory devices, or other types of medium/machine-readable medium suitable for storing electronic instructions.

As used herein, a software module or component may include any type of computer instruction or computer-executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

The foregoing specification has been described with reference to various embodiments, including the best mode. However, those skilled in the art appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “couple,” and any other variation thereof are intended to cover a physical connection, an electrical connection, a magnetic connection, an optical connection, a communicative connection, a functional connection, and/or any other connection.

Principles of the present disclosure may be reflected in a computer program product on a tangible computer-readable storage medium having computer-readable program code means embodied in the storage medium. Any suitable computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture including instruction means which implement the function specified. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified.

Principles of the present disclosure may be reflected in a computer program implemented as one or more software modules or components. As used herein, a software module or component (e.g., engine, system, subsystem) may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that perform one or more tasks or implement particular data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools.

Embodiments as disclosed herein may be computer-implemented in whole or in part on a digital computer. The digital computer includes a processor performing the required computations. The computer further includes a memory in electronic communication with the processor to store a computer operating system. The computer operating systems may include, but are not limited to, MS-DOS, Windows, Linux, Unix, AIX, CLIX, QNX, OS/2, and Apple. Alternatively, it is expected that future embodiments will be adapted to execute on other future operating systems.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Various operational steps, as well as components for carrying out operational steps, may be implemented in alternative ways depending upon the particular application or in consideration of any number of cost functions associated with the operation of the system; e.g., one or more of the steps may be deleted, modified, or combined with other steps.

While the principles of this disclosure have been shown in various embodiments, many modifications of structure, arrangements, proportions, elements, materials and components, used in practice, which are particularly adapted for a specific environment and operating requirements, may be used without departing from the principles and scope of this disclosure. These and other changes or modifications are intended to be included within the scope of the present disclosure.

The scope of the present invention should, therefore, be determined only by the following claims.

What is claimed is:

1. A global adjustment controller of an electrical system, the global adjustment controller comprising:
a data storage device to store historic peak demand data for a utility;
a communication interface to communicate with a system controller of an electrical system;
one or more processors operably coupled to the data storage device and the communication interface, the one or more processors configured to:
forecast the utility electricity load for an upcoming period;
compare a forecasted load of the upcoming period to a power threshold;
identify the upcoming period as a candidate utility peak period when the forecasted load for at least one segment of the upcoming period is above the power threshold, wherein the candidate utility peak period is a span of time in which it is possible a utility electricity peak segment will occur;
generate, for the candidate utility peak period, a probabilistic forecast comprising probabilities for segments of the upcoming period indicating potential of the utility electricity peak occurring during a specified segment;
provide, via the communication interface, the probabilistic forecast to an economic optimizer of the system controller, wherein the probabilistic forecast is used as a parameter for a cost function to determine one or more parameters to effectuate a change to the electrical system to attempt to participate in a system peak utility program.

2. The global adjustment controller of claim 1, wherein the upcoming period is 24 hours and each of the segment is an hour.

3. The global adjustment controller of claim 1, wherein the power threshold is an average of a set of latest historical utility peaks.

4. The global adjustment controller of claim 1, wherein the power threshold is a minimum of a set of latest historical utility peaks.

5. The global adjustment controller of claim 1, wherein the power threshold is a minimum of a set of utility peaks that happened during a previous year.

6. The global adjustment controller of claim 1, wherein the forecasted load for each segment is compared to the power threshold to identify the upcoming period of the as the candidate utility peak period.

7. The global adjustment controller of claim 1, wherein a minimum of the forecasted load is compared to the power threshold to identify the upcoming period of the as the candidate utility peak period.

8. The global adjustment controller of claim 1, wherein a maximum of the forecasted load is compared to the power threshold to identify the upcoming period of the as the candidate utility peak period.

9. The global adjustment controller of claim 1, wherein an hourly average of the forecasted load is compared to the power threshold to identify the upcoming period of the as the candidate utility peak period.

10. The global adjustment controller of claim 1, wherein how many segments and associated probabilities are in the probabilistic forecast is correlated to the energy size and inverter power of an ESS of the electrical system

11. The global adjustment controller of claim 10, wherein the processors are further configured to renormalize the probabilities in the probabilistic forecast based on how many segments and associated probabilities are in the probabilistic.

12. The global adjustment controller of claim 1, wherein the processors are further configured to pad probabilities for one or more segments before a predicted utility electricity peak and one or more segments after the predicted utility electricity peak.

13. The global adjustment controller of claim 1, wherein a machine learning neural network regression algorithm forecasts the utility electricity load.

14. The global adjustment controller of claim 1, wherein to generate the probabilistic forecast, every fifteen-minute interval of the candidate utility peak period, the processors forecast peak segments of the upcoming period using a machine learning classification model.

15. A method for controlling an electrical system, the method comprising:
receiving historic peak demand data for a utility;
forecasting the utility electricity load for an upcoming period based on the historic peak demand data;
comparing a forecasted load of the upcoming period to a power threshold;
identifying the upcoming period as a candidate utility peak period when the forecasted load for at least one segment of the upcoming period is above the power threshold, wherein the candidate utility peak period is a day in which it is possible a utility electricity peak segment will occur;
generating, for the candidate utility peak period, a probabilistic forecast comprising probabilities for segments of the upcoming period indicating potential of the utility electricity peak occurring during a specified segment;
providing, via a communication interface, the probabilistic forecast to an economic optimizer of the system controller, wherein the probabilistic forecast is used as a parameter for a cost function to determine one or more parameters to effectuate a change to the electrical system to attempt to participate in a system peak utility program.

16. The method of claim 15, wherein the upcoming period is 24 hours and each of the segments is an hour.

17. The method of claim 15, wherein the power threshold is an average of a set of latest historical utility peaks.

18. The method of claim 15, wherein the power threshold is a minimum of a set of latest historical utility peaks.

19. The method of claim 15, wherein the power threshold is a minimum of a set of utility peaks that happened during a previous year.

20. The method of claim 15, wherein the forecasted load for each segment is compared to the power threshold to identify the upcoming period of the as the candidate utility peak period.
